(19) United States
(12) Patent Application Publication
(10) Pub. No.: US 2002/0120490 A1
(43) Pub. Date: Aug. 29, 2002

(54) Vehicle systems concept development process

(76) Inventors: Arthur Joseph Gajewski, Canton, MI (US); Neil Garard Maguire, Commerce, MI (US)

Correspondence Address: Artz & Artz, P.C., 28333 Telegraph Road, Suite 250, Southfield, MI, 48034, US

(21) Appl. No.: 09/793,211

(22) Filed: Feb. 26, 2001

(51) Int. Cl. G06F 17/60

(52) U.S. Cl. 705/10

(57) ABSTRACT

Two vehicle systems concept development processes (VSCDPs) are provided. Both VSCDPs are for a company having a global marketing and sales unit, a business planning unit, and an engineering unit. The global marketing and sales unit, the business planning unit, and the engineering unit in the first VSCDP utilize system program planning, requirements driven customer ready development, and system design optimization and manufacturing planning techniques in combination with predetermined inputs to create outputs. The global marketing and sales unit, the business planning unit, and the engineering unit in the second VSCDP utilize project ready, concept demonstration ready, and application ready techniques in combination with predetermined inputs to create outputs. The engineering unit includes a vehicle system management unit, a lead vehicle system engineer, a vehicle functional system engineer, an enabling technologies/research group, and a strategic business unit (SBU) engineering and strategic partners group.

### TECHNICAL FIELD

The present invention relates generally to a systems process approach particularly suited for the automobile industry and more particularly, to a process for vehicle systems concept development.

### BACKGROUND OF THE INVENTION

Currently existing processes include EIA-632 (Electronic Industries Alliance) and IEEE 1220 (Institute of Electrical and Electronics Engineers, Inc.). EIA began development of the EIA-632 in 1994 and it was released and approved in January of 1999. The EIA-632 was developed by the International Council on System Engineering (INCOSE) and the Department of Defense. The purpose of the EIA-632 was to provide an integrated set of fundamental processes to aid a developer in the engineering or reengineering of a system. This process was to provide a standard for use in commercial enterprises as well as governmental agencies and their development contractors. The purpose of the IEEE 1220 was to provide a standard that defines the interdisciplinary tasks that are required throughout a system's life cycle to transform customer desires, system requirements, and constraints into a system solution. This standard was intended for guiding the development of systems (that include computers and software) for commercial, government, military, and space applications.

The EIA-632 contains five main sub-clauses, each sub-clause containing several engineering processes. There are a total of thirty-three requirements in the engineering processes that make up the system. In the IEEE 1220 the building blocks of a system are discussed from a part level up to a system level.

Disadvantages associated with the IEEE 1220 process include the fact that it is generic and has been developed around software and aerospace/defense ways of doing business. A shortcoming with both the EIA-632 and IEEE 1220 process is that they both are focused on the engineering system or process. By focusing only on the engineering system or process, other focus area's interests are not taken into account. It would therefore be desirable to provide a process that is refined for automotive vehicle applicability that includes more deliverables, and produces a total customer solution.

### SUMMARY OF THE INVENTION

A vehicle systems concept development process (VSCDP) uses a market driven set of requirements, fed into a system engineering approach, to develop and validate a vehicle system design solution that satisfies those market requirements.

Two VSCDPs are provided. Both VSCDPs are for a company having a global marketing and sales unit, a business planning unit, and an engineering unit. The global marketing and sales unit, the business planning unit, and the engineering unit in the first VSCDP utilize techniques in a system program planning phase, a requirements driven customer ready development phase, and system design optimization and manufacturing planning phase in combination with predetermined inputs to create outputs. The global marketing and sales unit, the business planning unit, and the engineering unit in the second VSCDP utilize techniques in a project ready phase, a concept demonstration ready phase, and the application ready phase in combination with predetermined inputs to create outputs. The engineering unit includes a vehicle system management unit, a lead. vehicle system engineer, a vehicle functional system engineer, an enabling technologies/research group, and a strategic business unit (SBU) engineering and strategic partners group. The vehicle system management unit may not be a subset of the engineering unit but a separate incorporated unit.

The present invention has several objects; first, it ensures a systematic approach that increases first pass success rate and customer/user satisfaction, and in so doing stakeholder requirements are satisfied. Second, this invention creates implementation ready, reusable engineering. Third, the present invention reduces the cycle time for applying the system concept to specific vehicle programs. Forth, the invention enables the management of process complexity. Fifth, the invention is adaptable and can be adapted to use with any vehicle system and vehicle system application. Sixth, the present invention allows development personnel to clearly understand what their deliverables are and what value they add to the project.

The present system ensures that all business, regulatory and customer requirements are identified and applied hierarchically to all systems, subsystems, and components. Furthermore it ensures that alternative designs are created and analyzed with respect to the vehicle system requirements and all designs are verified versus the vehicle system requirements. This process ends with proven designs, complete requirement documents, and detailed manufacturing processes.

The present invention itself, together with further objects and attendant advantages, will be best understood by reference to the following detailed description, taken in conjunction with the accompanying drawing.

### BRIEF DESCRIPTION OF THE DRAWING

FIG.1A is a flow chart illustrating a process, describing a system program planning phase according to the present invention.

FIG.1B is a flow chart illustrating a process, describing a requirements driven customer ready development phase according to the present invention.

FIG.1C is a flow chart illustrating a process, describing a system design optimization and manufacturing planning phase according to the present invention.

FIG.2A is a flow chart illustrating a process, describing a project ready phase according to the present invention.

FIG.2B is a flow chart illustrating a process, describing a concept demonstration ready phase according to the present invention.

FIG.3 is an N-squared chart, describing details on engineering functions, sequence, and outputs referred to by the present invention.

### DETAILED DESCRIPTION OF THE PREFERRED EMBODIMENT

In the following figures the same reference numerals will be used to refer to the same components. While the present invention is described with respect to an automotive vehicle process, the following process may be used for other various purposes and is not limited to use with automobiles, commercial vehicles, government vehicles, or any other vehicle. Also, although the present invention is described with respect to vehicle systems it may be applied to non-vehicle systems. For example, the present invention may be applied to ground power generation systems, electric utility supplementation systems, theater systems, or other various systems.

A first embodiment, of the present invention contains a first vehicle systems concept development process (VSCDP) comprising three phases of concept development a systems program planning phase, a requirements driven customer ready development phase, and a system design optimization and manufacturing planning phase. The first VSCDP is for a company having a global marketing and sales unit (GM&S), a business planning unit (BP), and an engineering unit. The GM&S, the BP, and the engineering unit in the first VSCDP, utilize techniques in the system program planning phase, the requirements driven customer ready development phase, and the system design optimization and manufacturing planning phase in combination with predetermined inputs to create outputs. The GM&S includes one or more individuals from the global marketing and sales function of the company. The BP comprises one or more individuals from the business planning function of the company. The engineering unit includes a vehicle system management unit, a lead vehicle system engineer, a vehicle functional system engineer, an enabling technologies/research group, and a strategic business unit (SBU) engineering and strategic partners group. The vehicle system management unit refers to one or more individuals that are vehicle system engineer managers. Each step throughout the first VSCDP has a lead role, a support role (when applicable), the input from a previous step (if applicable), and the output/deliverable. The inputs and outputs mentioned throughout the first VSCDP are not all-inclusive and may be used or added to as desired.

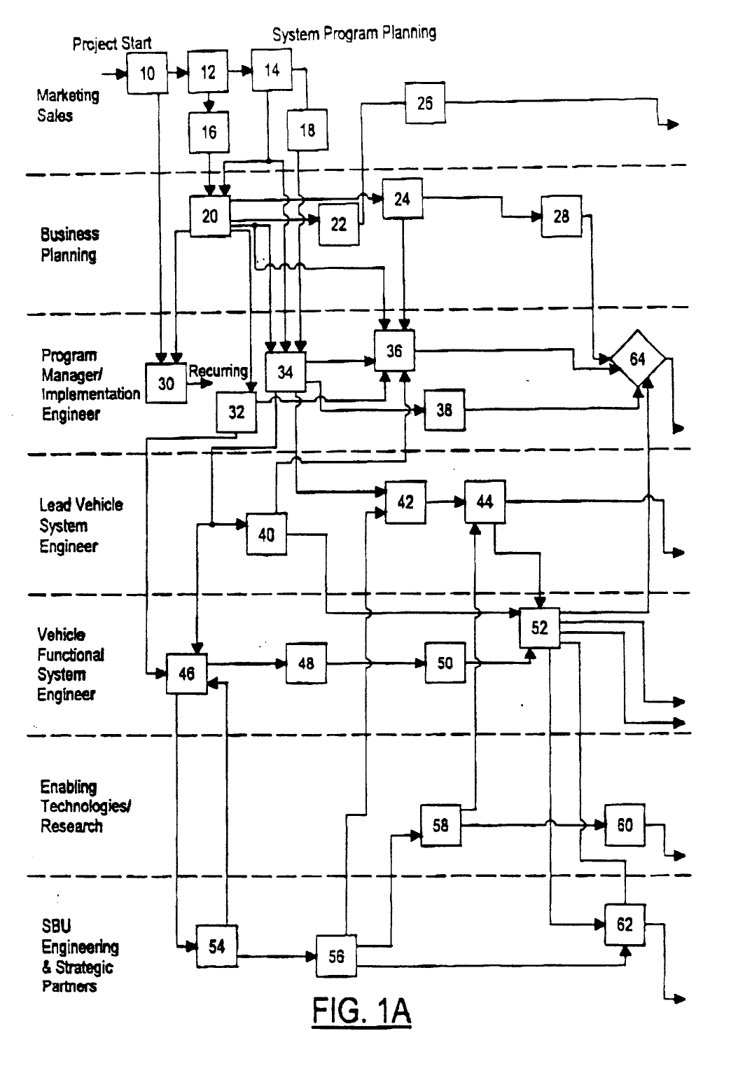

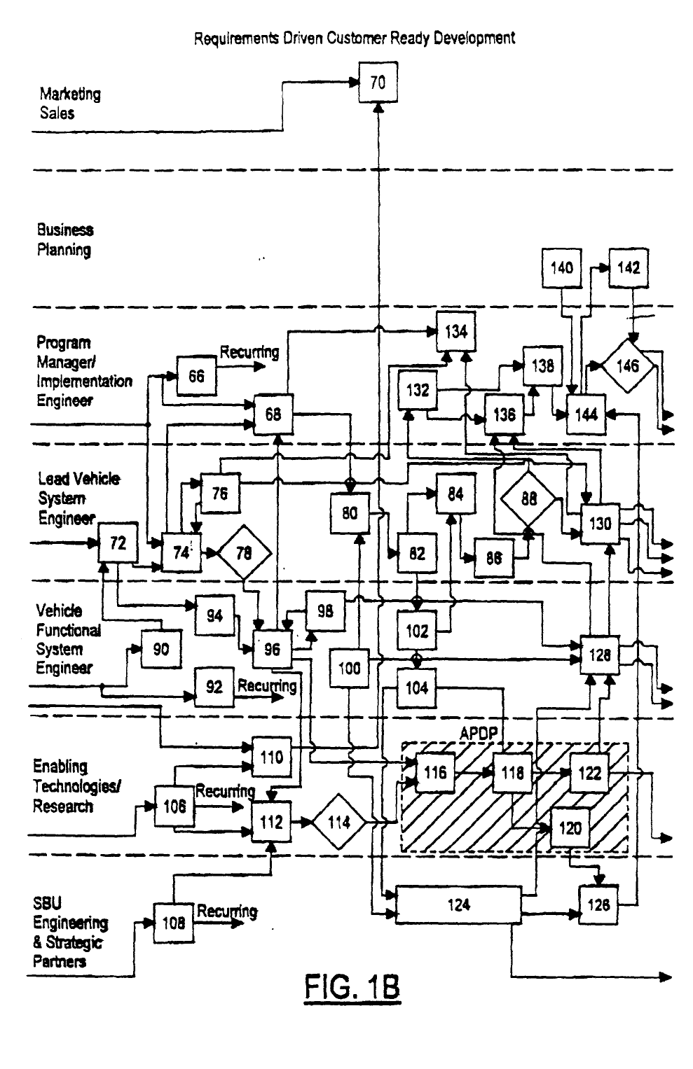

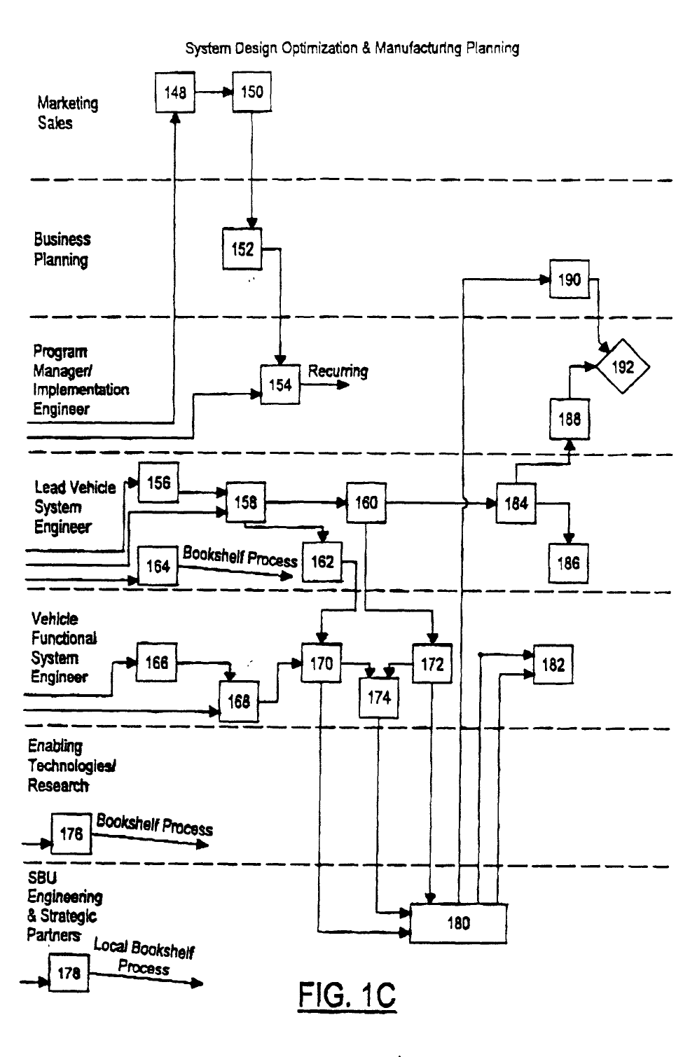

Now referring to FIG. 1A, the systems program planning phase includes preferably twenty-eight steps, each step containing systems program planning techniques. In step 10, the vehicle system start is initiated through a strategic marketing and corporate technology planning organization. A proposal response and a concept description are documented. In some cases external vehicle systems are initiated. GM&S perform the lead role. A team performs the support role. The output is a proposal response and a concept description.

In step 12, compiling and defining relevant marketing data and product plans for the vehicle system is performed. Also searches to identify existing market data for target vehicle segments are conducted. Market data may include industry trends for systems under development, competitive analysis, current market shares, strategic business unit (SBU) market data, and current product portfolio offerings. Gaps are identified in the market data and actions are initiated to obtain data to fill in the gaps. GM&S perform the lead role. The BP performs the support role. The input is the proposal response. The output includes target market data, product plans, and market strategies.

In step 14, customer vehicle system assumptions and vehicle segment wants are gathered to define end-user questionnaire/information desires. Customer requirements through focus groups, market surveys, and interviews are identified. A quality function deployment (QFD) analysis is performed to identify or develop vehicle market segment wants. GM&S perform the lead role. The input is the target market data. The output includes vehicle system assumptions and timing and vehicle segment wants with QFD.

In step 16, market forecasts for the vehicle system under development and rationale for market share projections are developed. Using forecasts from the past, other potential non-automotive markets are identified and sales in those markets, as well as a current competitive profile are quantified. If a customer development contract is agreed upon then customer volumes as well as overall segment volumes are identified. GM&S perform the lead role. The input is the target market data, product plans, and the market strategy. The output is market forecasts.

In step 18, vehicle metrics for attributes are established. Market segment attribute data such as average fuel economy, weight and vehicle prices for target segment are identified. A baseline vehicle is chosen for customer ready (CR) development in terms of all attributes: weight, emissions, electromagnetic compatibility (EMC) , fuel economy, cost, etc. Targets for improvements based upon results from similar vehicle systems or engineering estimates are set. GM&S perform the lead role. The support role is performed by the BP. The input is the vehicle system assumptions and planning and the vehicle segment wants with QFD. The output includes vehicle metrics.

In step 20, defining vehicle system objectives and business plans, and obtaining SBU alignment are performed. This is done by identifying the existing business case and investment analysis, quantifying functional and business benefits, ensuring compatibility with corporate strategies and SBU alignment, defining feasible business and product plans, identifying strategic partners, and initiating formal involvement through purchasing. Updated vehicle system and technology roadmaps are gathered from the SBUs. Vehicle system descriptions, revenue forecasts, or other data that was compiled during a concept selection process are obtained. The BP performs the lead role. The support role is performed by the SBU. The input is the forecasts, product roadmaps, market strategy, technology roadmaps, and vehicle system assumptions and timing. The output includes existing business cases, existing investment analysis, product plans, SBU and strategic partner's resource alignment, and vehicle system objectives.

In step 22, the basis for competition and pricing strategy are defined in order to be a technology leader with the following constraints high profit margins, availability in the market place, level of innovation and resulting benefits in fuel economy, emissions, and performance. This step involves analyzing the available marketing data, product plans and current cost structures to determine the basis of competition and establishing a pricing strategy. The BP performs the lead role. GM&S perform the support role. The input is the product plans. The output is a pricing strategy.

In step 24, capital appropriations and budgets are obtained, including estimating capital expenses and defining benefits to making the investment. The capital appropriation request is completed and process is initiated to gain approval and funding. Budgets are established based on vehicle system scope and level of supplier involvement. The BP performs the lead role. The input is the existing business cases and the existing investment analysis. The output is capital funds and budgets.

In step 26, a market portfolio is created. The market portfolio is a systems product portfolio for the vehicle system under development. A marketing organization should be planning for customer technical presentations and industry shows and events. The vehicle system at this stage has high risk and may be dropped prior to customer ready approval. GM&S perform the lead role. The input is the pricing strategy. The output is the marketing portfolio.

In step 28, a business case for a vehicle system planning review is developed based on latest resource desires, budgets, pricing strategy and market forecasts. The BP performs the lead role. GM&S, and the SBU perform the support role. The input is the existing business cases, investment analysis, and capital appropriations and budgets. The output is the business case.

In step 30, the program manager (PM) establishes a project evidence book. The project evidence book shall contain a request for quote (RFQ) development contract, RFQ response, vehicle system objectives, generic process and planning documents, marketing data and customer/end-user assumptions if applicable. The lead role is performed by the PM. The input is the concept description and/or proposal response, and the vehicle system objectives. The output is the project evidence book.

In step 32, a team is formed and roles and responsibilities are defined including defining the resource desires based upon the vehicle system objectives and the preliminary SBU and strategic partner resource commitments. A concept development process defines roles and responsibilities of team members. The project manager assigns steps. The project manager performs the lead role. This step is recurring. The input is the vehicle system objectives, SBU and strategic partners'resource alignment. The output is a project team roster including roles and responsibilities.

In step 34, the vehicle system requirements are defined by performing four main sub-steps. The first sub-step is identifying the regulatory and corporate standards. Second the customer assumptions, timing, standards, and vehicle metrics into vehicle system requirements are translated. Third the component/vehicle feature content matrix is defined. Forth the vehicle architecture and modularity assumptions are consolidated. Regulatory and corporate standards may include worldwide customer requirements (WCR), subsystem standards and guidelines, communication standards, EMC and recyclability standards, and material and manufacturing standards. Customer and vehicle system assumptions include the timing implications, vehicle wants and needs, and regional and country specific requirements. The feature matrix is defined based on the customer wants and needs and the technology roadmaps from the SBUs. Customer plans for modular assemblies and vehicle architecture are also required to effectively describe the environment that the vehicle system will be contained in and identify potential opportunities for modular assemblies. QFD can be used to derive vehicle system requirements that relate to vehicle segment wants and customer requirements. The project manager performs the lead role. GM&S perform the support role. The input is the vehicle system objectives, product plans, vehicle system assumptions and timing, vehicle segment wants, vehicle metrics, and the resources and roles. The output includes vehicle system requirements and timing, the Feature Matrix, and the Program Letter.

In step 36, the vehicle system is planned by assessing vehicle system risks and issuing and preparing a 7-panel chart. The 7-panel chart tracks issues, action items, team contacts, etc. A vehicle system work plan is developed. Also customer and internal vehicle system reviews are defined. A review of past documents is done to find reusable applicable documents. Obtaining input on systems engineering steps from the lead and functional systems engineers customizes a generic systems vehicle system plan. The duration of tasks and specific names associated with each task based on vehicle system requirements and team rosters is identified. Milestones and internal and external reviews based on vehicle system specific timing events are identified. Vehicle system tracking documents including 7-panel chart and vehicle system plan are initiated. The 7-panel chart should be distributed to the core and support team to solicit feedback on the resource and technical issues and the timing concerns. All team members must be committed to the plan prior to release. In each SBU and in the Enabling Technology organization component detailed product development steps are being performed. It is necessary to identify key interim deliverables due by each group and communicate through green, yellow, red (GYR) Status Reports on these deliverables. The project manager performs the lead role. The Lead System Engineer (LSE) performs the support role. The input is the vehicle system requirements and timing, feature matrix, product plans, capital funds and budgets, project team roster, roles and responsibilities, and designated vehicle systems steps. The output is the vehicle system plan and the 7-panel chart.

In step 38, the metrics are established by conducting vehicle benchmarking and develop design to cost objectives. Also a baseline analysis of attributes and assign system targets is conducted. The PM, at the vehicle level, establishes the best in class targets for attributes that they will track for the vehicle system. The attributes include fuel economy, emissions, cost, electrical features, etc. The best in class targets are found by performing a marketing data and competitive analysis and by leveraging vehicle tear down capabilities. Additional product costing and attribute baselines may need to be developed by acquiring vehicles and initializing a benchmarking study. Value Mapping analysis of competitor's systems may be initiated. The project manager performs the lead role. The BP and the LSE perform the support role. The input is the vehicle system requirements and timing. The output is the vehicle system attribute targets.

In step 40, the system engineer (SE) plans and defines applicable vehicle systems engineering steps, methodologies and tools to support vehicle system efforts, and internal technical reviews. The SE identifies the steps related to engineering and is necessary and sufficient to meet the vehicle system objectives. The rationale and justification for scaling down the deliverables set must be documented and agreed upon prior to a vehicle system planning review. The corporate system group should be used to access the overall plan and rationale, in order to add the expertise and management level credibility to the application of the present invention. The SE establishes the frequency of design reviews at the vehicle level. The process contains two reviews, a technical vehicle system requirement review and a critical design review. Additional reviews may be added. These reviews involve the core team and may also include technical specialists, reliability engineers, serviceability engineers, and experts in other attributes such as noise vibration and harshness (NVH), and EMC. Material prepared for the meetings should be completed and distributed prior to the meeting to allow specialists time to independently review the material in detail. Verification of bookshelf material, warranty analysis, failure modes effects analysis (FMEA) input, and design rules based on manufacturing constraints and lessons learned occurs in a meeting to develop vehicle system requirements and designs. The bookshelf is a repository of best practices and reusable documents that allow vehicle system teams to shorten development cycle times. The bookshelf is not a library that contains all vehicle system material gathered over time. Proposed material is formally reviewed and dated prior to placement on the bookshelf. The lead role is performed by the LSE. The input is the program letter. The output includes the designated vehicle systems steps and vehicle systems methodologies and tools.

In step 42, a high-level power generation or other applicable high-level system architecture including partitioning and power budget is established. Vehicle level metrics and segment wants with no assumption or constraints on the high-level system architecture may be looked at. An initial power budget may be established based on the desired features such as air conditioning, power steering, all-wheel drives, etc. The lead role is performed by LSE. The project manager performs the support role. The input is the feature matrix. The output is the power generation architecture assumptions and the power budget.

In step 44, the vehicle system assumptions are translated into system technical assumptions and technology gaps are identified. The vehicle system assumptions and architecture plans are analyzed from a technical standpoint with respect to vehicle system timing. This analysis results in system level technical assumptions that carry over content, new technologies, manufacturing assumptions, and vehicle content. Technology gaps are determined based on vehicle system objectives and timing and technology roadmaps provided by the SBUS. The enabling technologies (ET) group, upon receiving the technology, should initiate a scoping activity to define the resources and a timing plan for filling the technology gap. The lead role is performed by LSE. The ET performs the support role. The input is the power generation architecture assumptions and power budget, vehicle system plan (including timing), the 7-panel chart, and the vehicle system attribute targets. The output is the vehicle system technical assumptions and product and technology gaps.

In step 46, a subsystem team roster is established and provided. The functional subsystem engineer (FSE) gives the initial vehicle system requirements to the SBUs so that they may identify specific individuals from their various functional areas that will support the overall development effort. The list of subsystem team contacts is delivered to the PM by the FSE. The lead role is performed by the FSE. The SBU and the BP perform the support role. The input is the project team roster, roles and responsibilities of team members, a program letter which clearly defines the scope of the overall effort and a list of deliverables that are required, and the feature matrix. The output is the subsystem team roster and roles.

In step 48, benchmark research is conducted. Each subsystem team member should perform a benchmark analysis and a literature search on competitive product plans and hardware to understand their lessons learned and strategic direction. The focus of this step should be both automotive and non-automotive. The FSE and the SBU perform the lead role. The input is the team roster and roles. The output is the subsystem benchmark study.

In step 50, the patent strategy is established. The FSE requests patent searches. An approach to licensing or patenting ideas is determined. Vehicle subsystem/system strategies that are potential patentable ideas are identified and invention disclosures are submitted. SBU's and ET develop and implement patent strategies on their component level advancements. The lead role is performed by the FSE. The support role is performed by the SBU. The input is the subsystem benchmark study. The output is the patent strategy.

In step 52, vehicle subsystem assumptions and development plans are created, internal reviews are scheduled and an initial vehicle system Green Yellow Red (GYR) status report is created. The FSEs are responsible for coordinating the functional vehicle subsystem development plans and creating a list of technical and vehicle system assumptions based on the high-level vehicle system technical assumptions. The FSE uses only assumptions that are relevant to the functional vehicle subsystem. The vehicle system plans should be developed with a cross-functional SBU team using input from their product and technology roadmaps. Patent strategy and sourcing plans must be included in the functional vehicle subsystem development plans. A GYR status report is generated on a continual basis and is the formal communication on issues, risk and timing. The lead role is performed by the FSE. The support role is performed by the SBU. The input is the vehicle system technical assumptions, vehicle system plan, patent strategy, product and technology plans, vehicle system GYR status report (for components and ET), component development plans, and the make/buy analysis and sourcing plans. The output is the vehicle subsystem plan, the vehicle system GYR status report, and the make/buy analyses and sourcing.

In step 54, the SBU support team and roles that specific individuals are committed to perform, to support the vehicle system are defined. The SBU requires a program letter that clearly defines the scope of the overall effort and a list of deliverables that are required. Vehicle system timing should be included in the program letter. The SBU management and vehicle systems business planning must agree upon the set of deliverables and scope. The lead role is performed by the SBU. The BP performs the support role. The input is the program letter. The output is the team roster and roles.

In step 56, the baseline power consumption and product and technology desires are identified. An analysis of power consumption at 14V and 42V is conducted, this includes determining voltage to optimize component efficiency, defining product and technology desires, and defining and conducting benchmarking. The power generation and electrical distribution system shall be optimized. Data from during various loads for different driving conditions is obtained from corporate bookshelf knowledge. The data optimizes the power generation design. The customer/market driven feature matrix will be compared against current SBU advanced development efforts to identify product and technology gaps. A decision to pursue development must be made. If the SBU does pursue development than the technology gap is communicated to the ET group. The lead role is performed by the SBU. The support role is performed by the FSE. The input is the team roster, roles, and feature matrix. The output includes the product and technology gaps, the power consumption at 14V, 42V, and optimum voltage, and the benchmark data.

In step 58, products and technologies that will be targeted for development are determined. Technology desires are also determined. Research is performed on competitor advances, suppliers, trade shows, universities, and existing bookshelf material. The LSE and the SBUs will identify technology gaps between what the customer or vehicle system objectives are and what will be available in the timeframe dictated. ET is challenged with determining what products and technologies should be developed by conducting research within and outside of the industry. Proposed solutions will be ranked and investigated. If ET determines that the gap can not be closed, then communication to the PM and GM&S organizations is necessary to revise vehicle system objectives. ET performs the lead role. The input is the product and technology gaps. The output is the product and technology desires and different research findings.

In step 60, product and technology plans for defining the operational scenarios, functional and physical requirements, design completion target dates, prototype availability dates, and resources required internally and externally are established. This plan will be communicated to the FSE and the PM throughout the development cycle. The ET performs the lead role. The input is the product and technology desires, research findings, vehicle subsystem technical assumptions, and vehicle system plan. The output is the product and technology plans, the vehicle system GYR status report, and the product and technology assumptions.

In step 62, assumptions are established and component development plans and make/buy recommendations are defined. The functional vehicle subsystem technical assumptions, benchmarking and power consumption data are used to define a set of steps with timing and dependencies that are necessary to support the vehicle system objectives. SBUs must lead the effort in identifying capable sources in developing the vehicle subsystem components. The initial plan and the GYR status report are delivered to the PM and the FSE. Component assumptions are generated where appropriate without restricting development by specifying existing detailed designs. The lead role is performed by the SBU. The input is the benchmark data, vehicle subsystem technical assumptions, and the vehicle system plan. The support role is performed by the FSE. The output is the component development plans, the vehicle system GYR status report, the component assumptions, and the make/buy analysis and sourcing plans.

In step 64, the vehicle system plan is reviewed. A system program planning phase exit review is performed by the management and team on the primary deliverables of the phase. A gate review approval form is included to provide a checklist for these desirables. To pass the gate review all deliverables must be complete with the exception of limited and contained action items that will not effect overall timing. The lead role is performed by the PM. The team performs the support role. The input is the vehicle system attribute targets, vehicle system plan 7-panel chart, business case, vehicle subsystem plans, vehicle system GYR status report, and the make/buy analyses and sourcing plans. The output is the management sign-off on the gate review approval form.

Now referring to FIG. 1B, the requirements driven customer ready development phase includes preferably thirty-nine steps, each step containing requirements driven customer ready development techniques.

In step 66, the vehicle system management updates a system evidence book, implements and manages vehicle system plan, and reviews the bookshelf for reusable deliverables. The vehicle system plan, the 7-panel chart, and the attribute targets are distributed to the team following a vehicle system planning review. The vehicle system plan and other vehicle system issues are reviewed, during team meetings. Step 66 is recurring. The lead role is performed by the PM. The team performs the support role. The input is the gate review sign-off. The output is the updated vehicle system plan and vehicle system status updates.

In step 68, attribute data is compiled and managed. A sample list of attributes are as follows: safety, security, packaging, thermal/aerodynamics, vehicle dynamics, emissions, performance and fuel economy, NVH, electrical/electronics, interior climate comfort, weight, product/process design compatibility, customer life cycle, styling, and cost. Attribute targets are established based on customer/vehicle system metrics developed from vehicle level benchmarking and an analysis of market segment best-in-class vehicles. These attribute targets are established by the vehicle system manager with input from the system engineers. The LSE is responsible for identifying the cascade of attributes to the subsystems and components. The FSEs must continue the cascade to their components and provide updated data and feedback to the PM. The lead role is performed by the PM. The FSE and LSE perform the support role. The input is the vehicle system attribute targets, subsystem attribute targets, and component attribute targets. The output is vehicle build timing.

In step 70, marketing displays and brochures are created with the understanding that the technology is not ready for specific vehicle applications. ET and systems engineers support this effort through the publication of articles and reports, by providing CAE graphics and reviewing technical content. GM&S perform the lead role. ET performs the support role. The input is the articles, reports, and the marketing portfolio. The output is the marketing material.

In step 72, system operational behavior and strategies (load shedding, modes and states) are defined in so describing the primary functions of the vehicle system followed by operational behavior and interactions. This provides the basis for describing the modes of vehicle system operation and the states of all effective vehicle subsystems. This strategy has the largest impact on the performance of vehicle attributes such as emissions at idle, fuel economy, performance, NVH, etc. The lead role is performed by LSE. The support role is performed by FSE. The input is the vehicle system technical assumptions, the power budget, and the subsystem operational modes and states. The output is the vehicle systems operational behavior and strategies.

In step 74, detailed vehicle system requirements are created. This step defines system boundaries, identifies vehicle system attributes applicable to vehicle subsystems and assigns targets, defines life cycle requirements and constraints, creates a system requirements document (SRD), reviews functional SDS's and identifies applicable vehicle system requirements, and defines a verification method. Vehicle system boundaries are developed based on customer/market assumptions. Vehicle system attribute targets are set by the PM based on the vehicle metrics established by marketing. The lead system engineer must identify the cascade of attributes to effected vehicle systems and vehicle subsystems. Targets are established for vehicle subsystems based on historical data and preliminary development work. Life cycle requirements and current functional SDS's are reviewed. These sources of vehicle system requirements will be compiled in the SRD. The verification method associated with each requirement is identified. If a requirement is not verifiable then it is redefined with agreement of the customer/marketing contact. The lead role is performed by LSE. The support role is performed by FSE. The input is the interface control document, the vehicle system operation and strategies, the vehicle system technical assumptions, and the vehicle system attribute targets. The output is the vehicle subsystem attribute targets, SRD, and a boundary or system context diagram as known in the art.

In step 76, an interface analysis is performed, defining external interfaces, defining secondary impacts, and assigning vehicle system requirements to interfaces (vehicle ground, EMC, life). The vehicle system is described as a “Black Box” with relationships and dependencies to other entities. The entities may be environmental, vehicle or non-vehicle subsystems, components, or humans. Interfaces are classified as functional, physical, environmental, or electrical. The system engineer should look for the indirect and direct interfaces. The lead role is performed by LSE. The support role is performed by FSE. The input is the boundary diagram. The output is the interface control document.

In step 78, the LSE and technical specialists review technical vehicle system requirements documents. This is a comprehensive review incorporating lessons learned, bookshelf documents, warranty analysis, and manufacturing and design rules. The lead role is performed by the LSE. The support role is performed by the FSE. The input is the vehicle subsystem attribute targets, the SRD (including interface diagram), and the boundary diagram. The output is the technical vehicle system requirements review minutes.

In step 80, a logical solution partitioning and first trade study is performed. This step conducts a functional analysis, creates customer ready (CR) concepts (load partitioning and voltage filtering/regulation, modules), defines alternative system configurations for CR, identifies selection criteria, and performs a first trade study to select initial system architecture and load partition for CR. The functional analysis includes: deriving functional decomposition, developing a functional block diagram, creating an initial system failure modes effects analysis (SFMEA), and performing functional CAE modeling. Logical solutions are created through an engineering analysis as in the art. A variety of techniques may be used: Hatley Pirbhai and other structural analysis methods, object oriented analysis, information modeling, and functional analysis. This VSCDP is based on the functional analysis. Using a listing of primary functions of the vehicle system, a functional block diagram is created. Modeling is performed, that simulates the vehicle system requirements and correlates the results to real world data. Modeling may satisfy many of the vehicle system requirements. The vehicle system requirements and functional decomposition are the building blocks of the SFMEA. The SFMEA is used to manage risk and to identify mitigating action items including missing vehicle system requirements. The functional block diagram allows the SE to create and propose innovative solutions. The option space analysis, which defines multiple physical solutions for each function is the recommended analysis to identify concepts for each function and configure these concepts into alternative systems. These alternative systems are visually represented as concept drawings or logic diagrams. A trade-off study is performed, rating the alternative systems by their strengths in meeting the vehicle system requirements. The importance to the customer and to a business is identified, thereby enabling the rating of relative importance of each category prior to rating the alternatives. Load partitioning and the overall power generation architecture are included in the first trade study. The lead role is performed by the LSE. The FSE and the PM perform the support role. The input is the vehicle build timing, the SRD, and the subsystem logical solutions. The output is the preliminary architecture description, the SFMEA, the functional block diagram, the CAE functional models, and the first trade study.

In step 82 preliminary CR system layouts and schematics are developed. The selection of an alternative system configuration enables the next level of design detail to be undertaken at the vehicle system level. Vehicle system schematics are initially developed and finalized as the functional subsystems' trade studies are completed and logic diagrams are translated into 2D and 3D physical schematics. Packaging studies and resulting layouts should be available for vehicle subsystem design efforts. The lead role is performed by the LSE. The input is the preliminary architecture description. The output is the vehicle system layouts and schematics.

In step 84, a physical partitioning and a second trade study are performed. This step includes updating CR concepts, re-defining alternative system configurations for CR, verifying selection criteria, and performing a second trade study to select final system architecture and load partition for CR. Communication and feedback regarding functional (logical) and physical schematics, functional modeling and corresponding analysis results, and design decisions requires coordination among lead system's steps and functional subsystem steps. This second trade study is required because of the iterative nature of vehicle system requirements cascade and proposed design alternatives. It will help define the optimum architecture and design alternatives available in the timeframe required for CR. The lead role is performed by the LSE. The support role is performed by the FSE. The input is the subsystem attribute targets, SRD, system functional block diagram, SFMEA, and system layouts. The output is the optimum architecture description and the second trade study.

In step 86, final CR system layouts, bill of materials (BOM), and schematics are developed. CR layouts and concept drawings originally developed in step 82 are updated. 3D physical drawings and a 3D layout in vehicle are created. The lead role is performed by the LSE. The input is the optimum architecture description. The output is the final CR layouts and 3D drawings.

In step 88, a critical design review is conducted by utilizing the broader expertise and technical specialists to review the vehicle system layouts and schematics, the updated SFMEA, the attribute results, and the trade studies. Engineering changes, costs, and resources required downstream are established by these design-related deliverables. This is the reason why a comprehensive and detailed review that incorporates lessons learned, bookshelf documents, warranty analysis, and manufacturing and design rules is required. The lead role is performed by the LSE. The support role is performed by the FSE. The input is the vehicle subsystem attribute targets, the SRD, the system functional block diagram, the SFMEA, and the system layouts. The output is the critical design review minutes.

In step 90, existing operating modes and states should be compiled and delivered to the LSE to enable their development of new system operational behaviors and strategies. The LSE will use this information as a basis for defining innovative strategies while understanding the impact on vehicle subsystems. This step is recurring. The lead role is performed by the FSE. The support role is performed by the SBU. The input is the subsystem technical assumptions. The output is the operating modes and states.

In step 92, the vehicle subsystem management establishes a vehicle subsystem evidence book, implements and manages the vehicle system plan, and reviews the bookshelf for re-usable deliverables. The vehicle subsystem plans, vehicle system GYR status reports, and vehicle subsystem technical assumptions are distributed to the team following the higher-level vehicle system planning review attended by the FSE. All SBU team members and the FSE attend a kick-off meeting. An owner of the subsystem team's planning steps should have been previously established in the subsystem team roster. The vehicle system plan is overviewed and weekly vehicle system reviews are established with agreed upon agenda and team rules. The lead role is performed by the FSE. The support role is performed by the SBU. The input is the vehicle subsystem plan, vehicle system GYR status report, and subsystem technical assumptions. The output is the updated vehicle system plans and the vehicle system status updates.

In step 94, system operational behavior and strategies (modes & states) are defined. The higher-level system operational strategy is provided to the functional subsystems. The resulting primary functions and operational behaviors and strategies for each subsystem are described in this step. This is accomplished by listing the various modes and states of operation of the vehicle subsystem and the sequence and timing relationships to the higher-level system or external entities. This list constitutes the initial approach to meeting the functionality required and provides the starting point for vehicle system requirements engineering efforts. The lead role is performed by the FSE. The support role is performed by the SBU. The input is the vehicle system operational behavior and strategies and system technical assumptions. The output is the subsystem operational behavior and strategies.

In step 96, detail vehicle subsystem requirements are identified. This step defines system boundaries, identifies subsystem attributes applicable to components and assigns targets, defines life cycle requirements and constraints, creates system requirements document (SRD), reviews functional SDS and identifies applicable vehicle system requirements, and defines verification methods. The lead role is performed by the FSE. The support role is performed by the SBU. The input is the subsystem operational behavior and strategies, vehicle subsystem attribute targets, SRD, and the vehicle subsystem interface control documents. The output is the boundary diagram, the subsystem SRD, the component attribute targets, and the subsystem operational strategy.

In step 98, an interface analysis is performed and a vehicle subsystem interface control documents are created. This analysis defines external interfaces and secondary impacts, and assigns vehicle system requirements to interfaces (ground, pin connections, voltage, filtering, and peak current). The lead role is performed by the FSE. The support role is performed by the SBU. The input is the boundary diagram. The output is the vehicle subsystem interface control documents.

In step 100, a logical solution subsystem partitioning and a third trade study are performed including creating CR concepts, defining alternative subsystem configurations for CR, identifying selection criteria, and performing the third trade study to select final subsystem architecture for CR. The lead role is performed by the FSE. The support role is performed by the SBU. The input is the SRD. The output is the subsystem logical solutions, the subsystem SFMEA, the functional block diagram, the CAE functional models, and the third trade study.

In step 102, a physical subsystem partitioning and a fourth trade study that updates CR concepts, re-defines alternative subsystem configurations for CR, verifies selection criteria, and selects a final subsystem architecture for CR is performed. The FSE and SBU coordinate their steps in order to make decisions on communications and feedback regarding functional (logical) and physical schematics, functional modeling and corresponding analysis results, and design. This fourth trade study is required because of the iterative nature of vehicle system requirements cascade and proposed design alternatives. The fourth trade study will enable definition of the optimum subsystem architecture and design alternatives available in the timeframe required for customer ready. The lead role is performed by the FSE. The support role is performed by the SBU. The input is the vehicle system layouts. The output is the optimum subsystem architecture description and the fourth trade study.

In step 104, the preliminary CR subsystem layouts, BOM and schematics are developed. This step is recurring. The lead role is performed by the FSE. The input is the optimum subsystem architecture description. The support role is performed by the SBU. The output is the vehicle subsystem layouts.

In step 106, an implement and manage vehicle system plan is developed from the team reviewing the vehicle system and technology vehicle system plans, the vehicle system GYR status reports, and the product and technology assumptions. This step is recurring. The ET performs the lead role. The input is the product and technology plans, the vehicle system GYR status report, and the product and technology assumptions. The output is the updated plans.

In step 108, the vehicle system plan including sourcing steps are developed and overviewed. Weekly vehicle system reviews are established with agreed upon agenda and team rules. The component development vehicle system plans, the vehicle system GYR status reports, and the component assumptions are distributed to the team following the higher-level vehicle system planning review attended by the FSE. The out sourcing steps are managed through purchasing and engineering. Critical lead times are established for prototypes and design deliverables. The lead role is performed by the SBU. The input is the component development plans, vehicle system GYR status report, component assumptions, make/buy analysis and sourcing plans. The output is the updated vehicle system plan.

In step 110, intellectual property and the patent strategy are defined. Patent searches are requested and an approach to licensing or patenting ideas is determined. A patent search is one of the first steps ET should undertake during their research efforts conducted when analyzing product and technology gaps. The proprietary vehicle subsystem operational strategies will be reviewed. A patent strategy should be established at the components level for all vehicle systems. In some cases licensing of patents may be required to avoid infringement. Intellectual properties include trade secrets that are not disclosed through the publicly accessible patents, copyrights, and trademarks. Invention disclosures should be submitted to the Patent and Trademark Office (PTO) The ET performs the lead role. The input is the patent strategy, the product and technology desires, and the product and technology plans. The output is intellectual property related articles and reports.

In step 112, a feasibility (expert) analysis on development plans of suppliers and functional units is performed. The feasibility analysis includes analysis of the development plans, vehicle system requirements, and design intentions of the SBU's, FSE's and strategic partners. The purpose of the feasibility analysis is to identify where unrealistic or overlying conservative milestones have been established and for providing recommendations for closure on these issues. The ET performs the lead role. The supporting role is performed by the FSE. The input is the product and technology assumptions and product and technology plans. The output is the issues and recommendations.

In step 114, a product and technology development plan review and a commitment on that product or technology occurs. The team, FSE's (if applicable), LSE, and PM are updated on the product and technology development plans and results of the same to date. The PM reviews the vehicle system timing and a decision is made as to whether or not the product or technology will be available for the customer ready yellow board and vehicle builds. The yellow board is an off-vehicle assembly of system components on a pegboard style rack. ET must commit to this timing or the product/technology must be removed from the feature content or power generation architecture. If a delay in timing is recommended on the CR target date, then it must be agreed upon between the PM, ET, and GM&S organization. After this commitment has been reached the risk to timing should be greatly diminished and the dates become firm on the high-level system plan. At this point the product and technology development plans become implementation plans. The ET performs the lead role. The support role is performed by the PM and LSE. The input is the issues and recommendations. The output is the implementation plan.

In step 116, the component requirements capture is developed. Component attribute targets are translated into design constraints and component requirements are defined and documented in preliminary component design specification (CDS). Component requirements capture depends upon the subsystem team for subsystem SRD, component attribute targets, and SFMEA's. The component requirements derived from the preliminary CDS, the subsystem SRD, the component attribute targets, and the SFMEA's should be linked to the vehicle subsystem requirements and documented accordingly in the CDS. The FSE's should be involved in this process by providing the vehicle system requirements and reviewing the linkage to the CDS and verification methods. The ET performs the lead role. The input is the implementation plan and component attribute targets. The output is the component requirements and the CDS.

In step 118, is the component design step. The component design step includes defining the DVP&R for customer ready, involving advanced manufacturing technology expertise, completing a detailed component design, completing a component design failure modes effects analysis (DFMEA), and submitting invention disclosures. Component design has several key deliverables that should be tracked at the vehicle system or vehicle subsystem level. These include DFMEA's, component drawings or schematics, and BOM's. Subsystem layouts and packaging information are required to complete this task. Advance manufacturing groups are involved to identify constraints in the existing manufacturing process and to investigate innovative manufacturing solutions. Design validation plans (DVP's) are defined and the vehicle system requirements and design parameters linked to vehicle subsystem requirements are reviewed with the appropriate FSE or LSE. The ET performs the lead role. The input is the component requirements, CDS, and the subsystem layouts. The output is the component drawings and DFMEA.

In step 120, initial product cost is established based on long term market share and volume projections. The fixed cost of material and direct labor hours estimated by the advanced manufacturing groups should be compiled for each component in the BOM. A capital investment analysis is completed and re-billable tooling estimated. The SBU's complete cost estimates based on ET's established initial product cost. The ET performs the lead role. The input is the component drawings. The output is the cost estimate.

In step 122, a component build and a customer ready verification occurs. The component build and customer ready verification includes building and delivering component hardware, conducting component verification and validation, and ensuring packaging compatibility in vehicle. ET must identify their prototype source and establish costs and lead time for their components prior to this step. Upon completion of designs and appropriate design reviews with manufacturing and technical specialists, a prototype build of proof of principle hardware is initiated. Prototype requirements for performance measures and critical dimensions must be established and verified by the prototype source prior to delivery of the proof of principle hardware. Verification of the DFMEA must also be completed based on hardware. However, proof of principle hardware at this point may be experimental in nature and may not be “production intent”. Proof of principle hardware is for example a PC in a trunk. The ET performs the lead role. The input is the component drawings, design for manufacturing ease of assembly (DFMEA), and CDS. The output is the component CR hardware and the CR V&V reports.

In step 124, the SBU concept development process occurs. By this step each SBU should have its own development process. The SBUs should have the same level of detail and outputs as steps 2.22, 2.23, and 2.24 in their development processes. Timing for all deliverables must be established and managed in the higher-level system plan. The lead role is performed by the SBU. The input is the component attribute targets, subsystem SRD, subsystem SFMEA, subsystem operational strategy, functional block diagram, and subsystem layouts. The output is the component CR hardware, CR V&V reports, component drawings, DFMEA, component requirements, CDS, and manufacturing and product detail.

In step 126, the initial cost and attribute analysis is completed. Product cost must be established based on long term market share and volume projections. The fixed cost of material and direct labor hours estimated by the advanced manufacturing groups should be compiled for each component in the BOM. A capital investment analysis is completed and re-billable tooling estimated. Attribute detail must also be compiled and rolled up to the higher-level systems. These include the detailed measurement of weight, cost, emissions, fuel economy, serviceability, NVH, EMC, etc. The lead role is performed by the SBU. The input is the manufacturing and product detail and cost estimate (from ET if applicable). The output is the fixed cost and attribute details.

In step 128, subsystem build and CR verification and validation occur. The subsystem build and CR verification and validation defines a design verification plan, integrates and delivers the vehicle subsystem, and conducts proof of principle yellow board testing and creates a subsystem yellow board report. Verification methods listed in the SRD are exercised to verify each requirement. Vehicle system requirements are verified by CAE analysis, functional testing and physical testing. Acceptance tests, environmental limit tests, and functional performance output such as torque vs. rpm curves, timing, and heat dissipation establish the vehicle subsystem capabilities not verified at the component level. These tests are not merely a continuity check. The lead role is performed by the FSE. The input is the component CR hardware, CR V&V reports, subsystem SFMEA, CAE functional models, subsystem SRD, and vehicle subsystem interface control document. The output is the design validation plan (DVP), the subsystem CR V&V reports, the subsystem yellow board reports, and the subsystem customer ready hardware.

In step 130, a system CR verification and validation occurs. The system CR verification and validation defines overall vehicle system requirements to be verified at yellow board test and creates a system DVP. The vehicle system level verification and validation plan is finalized based on the SRD and higher-level requirements that can not be verified at the subsystem or component level. The vehicle system level verification may include EMC testing, vehicle level grounding, testing for interactions with other vehicle systems. Verification methods documented in the SRD are the basis for developing this plan. The vehicle system manager's will produce the components for the yellow board and build and test the vehicle system based on the DVP input provided by the LSE and FSEs. The LSE is responsible for interpreting the results, analyzing the root causes of issues, and performing trade-off studies on potential solutions. The lead role is performed by the LSE. The input is the subsystem DVP's, subsystem CR V&V reports, subsystem yellow board reports, system SFMEA, SRD, CAE functional models, and interface control documents. The output is the system DVP.

In step 132, the vehicle system hardware that is desired and build sheets are defined. Final CR layouts, bill of materials with part numbers, design levels, prototype sources, lead times and costs are provided by the LSE and FSEs to the PM. A build sheet detailing all the component part numbers and design levels, prototype source, lead time, and cost is compiled for the yellow board testing and the vehicle build. These parts are procured by PM for these builds. The lead role is performed by the PM. The input is the final CR layouts and component drawings. The output is a build sheet comprising the BOM, prototype source, and lead times. The output also includes vehicle build sheets.

In step 134, a system DVP is created. A separate test plan that validates the vehicle system in its intended environment is created. Road cycle tests for durability and performance are specified with resources and timing for conducting the tests. The system DVP is focused on customer requirements that have been cascaded through the requirements driven customer ready development phase. These should be objective tests not subjective jury evaluations. The lead role is performed by the PM. The input is the interface control documents, system attribute targets, and system DVP. The output is the DVP.

In step 136, subsystem CR hardware is acquired from the FSEs and the yellow board is built and tested. CR hardware yellow board test reports are created from the testing. The PM's layout the resources required and the testing duration based on the DVP's. PMs write requisitions for all hardware starting with long lead-time items. The yellow board is assembled and issues documented as material are received. Testing commences when the yellow board has been completed. The lead role is performed by the PM. The LSE and FSE perform the support role. The input is the system DVP, subsystem DVP's, build sheet, and subsystem CR hardware. The output is the CR hardware yellow board test reports.

In step 138, a proof of principle vehicle is built and validated in a functional vehicle drive evaluation. Yellow board hardware is moved into the proof of principle vehicle and tested according to the system DVP. Test incidences and anticipated integration efforts are documented and reported. The CR hardware may not represent production intent hardware and is therefore referred to as proof of principle hardware. The intention is to learn about vehicle system performance and interactions in a vehicle. The LSE, PM, and department manager (DM) must sign-off on a proof of principle validation report. The lead role is performed by the PM. The support role is performed by the LSE. The input is the vehicle build sheets, CR hardware, yellow board test results, and the design validation plan. The output is the proof of principal validation report and the functional vehicle drive evaluation.

In step 140, the business case and pricing is updated. The system program planning and requirements driven customer ready development phases typically last six months to two years. In this time the market size has changed, the competition has evolved, and the economic conditions are different. This requires a major refreshing of the business plan that launched the vehicle system. In addition cost studies on the vehicle subsystems and components can now be done. The BP performs the lead role. The support role is performed by the SBU. The input is the business case. The output is an updated business case.

In step 142, a level of tooling & manufacturing detail desired for implementation ready (IR) are defined. The IR is re-looked at with time, resources, and assets in mind. A recommendation may be given for advancing into IR which is supported by estimates of the investment that is suggested. This is dependent on the number and scale of new technologies being implemented in the vehicle system and the level of tooling and manufacturing process and facilities detail required. This step is a thorough assessment of the vehicle system team tasks involved in determining advancement. The result is an IR vehicle system plan and resources identifying the tooling and manufacturing capabilities involved at the proposed manufacturing sites, both internal and external, and of the engineering effort required to optimize the CR system architecture prior to designing production intent hardware. The BP performs the lead role. The support role is performed by the SBU. The input is the CR report. The output is the IR vehicle system plan and resources.

In step 144, CR/conceptual assessment recommendations are prepared. A CR report combining the engineering results from the yellow board and vehicle level testing with the updated market conditions, investment analysis and timing plans is created. Results of attribute efforts are summarized to provide the sales and marketing community with an updated data driven cost/benefit analysis. A summary report is prepared which focuses on how the vehicle system requirements engineering and design efforts meet the original customer requirements and what are the investment and business implications. The lead role is performed by the PM. The BP performs the support role. The input is the proof of principle report, functional vehicle drive evaluation, business case, and fixed cost and attribute details. The output is the CR Report.

In Step 146, customer readiness of the vehicle system is decided. This decision includes a formal exit review that results in a decision on the recommendation proposed by the team. If a recommendation to proceed is proposed, a commitment of resources is established provided that management approval is given on the deliverables. If a recommendation to exit is proposed and accepted the vehicle system team deliverables are identified and written in the lessons learned in the bookshelf. The deliverables are: a CR summary of system and subsystem architectures and targeted vehicle segment, a CR approval, SFMEA, final CR attribute data, design validation plan and results (DVP&R), system requirement documents, interface diagrams, functional block diagrams, layouts and schematics, vehicle build and integration reports, updated business case, IR vehicle system plan and resource desires, and functional vehicle drive evaluation. The lead role is performed by the PM. The team performs the support role. The input is the CR report. The output is the CR summary.

Now referring to FIG. 1C, the system design optimization and manufacturing planning phase includes preferably twenty-three steps, each step containing system design optimization and manufacturing planning techniques.

In step 148, an understanding of the vehicle segments that the product is CR for and appropriate customers are identified. The CR approval enables GM&S to actively sell the vehicle system to customers for specific applications within the vehicle segment that the vehicle system was developed for. For instance, if the vehicle system is CR for a “C class” vehicle it can be sold to any customer for “C class” applications. However, the vehicle system is not ready for other market segments such as trucks. A high level of risk is associated with trying to apply the vehicle system to these different vehicle system requirements. The sales effort should lead to an RFQ from a customer. The input, the RFQ, and the output, the RFQ Response, are deliverables exchanged between these processes. GM&S perform the lead role. The input is the CR summary. The output is the customer RFQ.

In step 150 a response to the customer RFQ is prepared based on the vehicle systems product portfolio that includes fixed cost and attribute details. The required information in the response is specified in the customer RFQ. GM&S perform the lead role. The input is the customer RFQ. The output is an IR contract.

In step 152, the CR process steps that should be tailored for a specific customer are identified by customizing the deliverables for the specific customer or the vehicle system selected for IR. The vehicle system scope is defined. To develop a system from CR to IR, a customer may be involved. If a customer is not involved, assumptions will have to be made concerning the vehicle system requirements. These assumptions enable the vehicle system team to refine the vehicle system requirements document and CR deliverables. This step is the optimization of system architecture and design, and the development of detailed manufacturing plans. The BP and PM jointly identify the scale of development to achieve outputs in this step. The deliverables, for this step, are available for reuse and the cycle time and risk level will be greatly reduced. The BP performs the lead role. The LSE and the PM perform the support role. The input is the IR contract. The output is the vehicle system scope.

In step 154, the vehicle system plan that includes the CR Report containing an assessment of tooling and manufacturing detail preferred to reach IR is implemented and managed. This assessment and the vehicle system scope are combined into a vehicle system plan that is accompanied by the team roster, 7 panel charts, and metrics. All core and support team members attend an IR kick-off meeting. The vehicle system plan is overviewed and weekly vehicle system reviews are established with an agreed upon agenda and team rules. This step is recurring. The lead role is performed by the PM. The input is the vehicle system scope and the CR Report. The output is an updated vehicle system plan.

In step 156, production intent partitioning occurs. Production intent partitioning defines internal interfaces, develops high-level system architecture/partitioning, creates concepts (load partitioning & voltage filtering/regulation, modules), and defines alternative system configurations. Typically many assumptions and compromises are made to develop a proof of principle system. This step optimizes the vehicle system design based on the vehicle system requirements by looking for opportunities for integration of functions across the vehicle. For example a vehicle may have 27 regulators providing 5 volt outputs. There may exist opportunities for combining this function centrally or at least communizing components. Innovative use of plastics and higher formability ferrous and nonferrous metals also offer solutions not possible without a systems view. There may be up to 35 microprocessors on a vehicle, each with common functions and each containing many interfaces that present opportunities for failure. This step consists of using methods such as option space, where individual physical solutions for each function are generated, brainstorming and others to generate alternative system configurations to the vehicle system requirements. The lead role is performed by the LSE. The support role is performed by the FSE. The input is the SRD and functional block diagram. The input is the SRD and functional block diagram. The output is the alternative system configurations.

In step 158, a system optimization trade study is performed which includes identifying vehicle system requirements that drive design, identifying selection criteria, performing a pugh analysis, a structural method for rating alternatives versus criteria, to identifying primary alternatives and create hybrids, and selecting final system architecture and load partition. The Pugh analysis is used to narrow the number of alternatives and identify hybrid systems that combine benefits of various alternatives. The system optimization trade study is used to identify the best alternative system configurations that meet the vehicle system requirements and attribute targets. To evaluate and select these alternatives, an analysis of the vehicle system requirements that “drive the design” is performed. The design drivers are those physical parameters that optimize the performance with respect to attributes such as NVH. These become the selection criteria when combined with business goals. The lead role is performed by the LSE. The support role is performed by the FSE. The input is the alternative system configurations and the SRD. The output is the selected architecture, depicted in architectural diagrams, which show the high-level system interfaces both external and internal and the SRD.

In step 160, preliminary system layouts, the BOM and schematics are designed. The layouts, schematics and BOM created here will be production intent and must provide manufacturing and tooling engineers with enough detail to determine processes and estimate costs. The lead role is performed by the LSE. The input is the architecture diagram. The output is the vehicle system layouts and schematics and bill of materials (BOM)

In step 162, a finalized cascade of vehicle system requirements to vehicle subsystems that update the vehicle system requirements document, verifying proof of principle and vehicle builds are completed. The selection of an optimized system architecture leads to a final cascade of vehicle system requirements to vehicle subsystems and components. The generic SRD should have placeholders for customer specific attributes such as maximum underhood temperature, peak G forces, maximum allowable interior noise, etc. As these TBD's are determined and system and subsystem architecture decisions are made, the vehicle system requirements are broken down into vehicle subsystem requirements that support the customer desires. Vehicle subsystems should also develop generic requirements for their bookshelves. The lead role is performed by the LSE. The support role is performed by the FSE. The input is the SRD. The output is the vehicle subsystem requirements.

In step 164, the bookshelf is updated with CR content including updating deliverables such as SRD's interface diagrams, trade studies, and CAE models, proformas, best in class designs, competitive analysis, and manufacturing design rules. This step should commence upon CR approval. The lead role is performed by the LSE. The input is the SRD and the SFMEA. The output is an updated Bookshelf.

In step 166, production intent partitioning is performed which defines internal interfaces, develops subsystem architecture/partitioning, creates concepts, and defines alternative system configurations. The lead role is performed by the FSE. The support role is performed by the SBU. The input is the SRD and the functional block diagram. The output is the alternative system configurations.

In step 168, a subsystem optimization trade study is performed. The subsystem optimization trade study identifies vehicle system requirements such as design drivers, identifies selection criteria, performs the pugh analysis to identify primary alternatives and create hybrids, and selects final vehicle subsystem architecture. See steps 80 and 156 for detailed description. The lead role is performed by the FSE. The support role is performed by the SBU. The input is the alternative system configurations and SRD. The output is the architecture diagram.

In step 170, vehicle subsystem attributes and requirements are cascaded components, see step 162 for detailed description. The lead role is performed by the FSE. The support role is performed by the SBU. The input is the architecture diagram and the vehicle subsystem requirements. The output is the vehicle subsystem attribute targets and the component attribute targets.

In step 172, subsystem layouts, BOM and schematics are developed (see step 158 for detailed description). The lead role is performed by the FSE. The input is the vehicle system layouts and schematics. The output is the vehicle subsystem layouts.

In step 174, CAE/CAD requirements from the selected alternative configuration are defined. The component dimensional or performance measures that effect subsystem modeling capabilities are defined and communicated to the component development teams. The subsystem modeling is dependent upon the values of several design parameters such as resistance values, inside diameters, thickness, etc. The lead role is performed by the FSE. The input is the subsystem attribute targets and the subsystem layouts. The output is the CAE requirements.

In step 176, technologies targeted for development, system requirement documents and designs are entered into the bookshelf, see step 164 for detailed description. The ET performs the lead role. The input is the component drawings, DFMEA, component requirements, and CDS. The output is an updated bookshelf .

In step 178, technologies targeted for development, system requirement documents and designs are entered into the bookshelf, see step 164 for detailed description. The lead role is performed by the SBU. The input is the component drawings, DFMEA, component requirements, and CDS. The output is the updated bookshelf.

In step 180, the SBU concept development process uses the vehicle subsystem requirements documents and layouts from the optimized subsystem architecture to complete the vehicle system requirements capture, component design, and component build and verification as discussed in steps 116, 118, and 122. The above is used by manufacturing to do a detailed process design and to produce or obtain tooling costs and lead-time based on customer volumes. A manufacturing facilities plan is created. Prototypes are built on production intent tooling. These prototypes are delivered for subsystem integration and attribute testing. Verification methods for each requirement are performed per the component design verification plans. The lead role is performed by the SBU. The input is the CAE requirements, subsystem layouts, and component attribute targets. The output is the DFMEA, manufacturing facilities plan, tooling costs, lead-time estimates, and cost and attribute analysis.

In step 182, subsystem metrics and a risk analysis, are defined, attribute data (packaging, weight, EMC, NVH) and detailed costs are summarized, and the subsystem SFMEA is completed based on a roll-up of components FMEAs. FSE's are responsible for performing a trade-off analysis on attributes based on component data provided by the SBU's. The ability to accurately perform the trade-off analysis is dependent upon the level of understanding of the cascade of attributes to the components and the tooling and manufacturing implications associated with alternative designs. If attribute targets are not met, the FSE's should present the options with respect to design and manufacturing so that the LSE can investigate solutions at the higher level system. Risk analysis is performed primarily through the linkages between subsystem FMEA's and component DFMEA's and PFMEA's. This linkage and roll-up of action items and a risk priority number (RPN) values must be verified with actual hardware. The lead role is performed by the FSE. The support role is performed by the SBU. The input is the DFMEA, manufacturing facilities plan, tooling costs and lead-time estimates, and cost and attribute analysis. The output is the SFMEA, cost analysis, technical metrics and attribute data, manufacturing facilities plan, and tooling cost and lead time estimates.

In step 184, a system metrics and risk analysis is performed. The system metrics and risk analysis freezes system architecture and design, completes analysis of technical measures and attributes, and finalizes SFMEA based on roll-up of subsystem/component FMEA's. A design freeze enables the completion of compiling vehicle subsystem technical measures and attributes. Vehicle system level trade-offs now can be performed to solve any issues with respect to meeting attribute targets and vehicle system requirements. The SFMEA is also finalized based on the ;roll-up of subsystem FMEA's and prototype test results. The lead role is performed by the LSE. The support role is performed by the FSE. The input is the bill of materials, BOM, SFMEA, cost analysis, technical metrics and attribute data, manufacturing facilities plan, and tooling cost and lead-time estimates. The output is the layouts, SRD, DVP, trade studies, SFMEA, cost analysis, and the technical metrics and attribute data.

In step 186, a detailed system bookshelf review is conducted, see step 164 for detailed description. The lead role is performed by the LSE. The input is the layouts, SRD, DVP, trade studies, manufacturing facilities plan, and tooling cost and lead-time estimates. The output is an updated bookshelf.

In step 188, the PM is responsible for producing the IR report including: verification and validation summary, final attribute and metric data, and the impact and investment to manufacturing facilities as agreed to by the manufacturing sites. Risks are identified and documented in the SFMEA. Vehicle system plans are completed and included. A recommendation if appropriate by the team for implementation readiness on vehicle systems is given. The lead role is performed by the PM. The BP performs the support role. The input is the SFMEA, cost analysis, and the technical metrics and attributes data. The output is the IR report.

In step 190, a detailed business case analysis with agreement from SBUs is completed. Product cost, re-billable tooling, and manufacturing investment is completed with agreement form the SBU's and manufacturing sites. Revenue projections and profitability is estimated based on customer volumes. The BP performs the lead role. The support role is performed by the SBU. The input is the manufacturing facilities plan, tooling costs and lead-time estimates. The output is the IR business case.

In step 192, a formal phase exit review, which results in a decision on the recommendation proposed by the team, is conducted. If a recommendation to proceed is proposed, a commitment of resources is established provided that management approval is given on the deliverables. If a recommendation to exit is proposed and accepted the team deliverables are identified in the lessons learned on the bookshelf. The deliverables are: SFMEA, DVP&R, technical metrics and attribute data, vehicle system requirement documents, interface diagrams, layouts and schematics, IR business case with SBU sign-off, manufacturing facilities plan, and tooling costs and lead times. The lead role is performed by the PM. The team performs the support role. The input is the IR business case and the IR Report. The output is a sign-off on IR.

A second embodiment of the present invention contains a second VSCDP comprising three phases of concept development a project ready phase, a concept demonstration ready phase, and an application ready phase. The application ready phase of the second embodiment is identical to the system design optimization and manufacturing planning phase of the first embodiment. The project ready phase combined with the concept demonstration ready phase is similar to the systems program planning phase combined with the requirements driven customer ready development phase, of the first embodiment, except that they provide a potentially shorter and more efficient method of accomplishing the same deliverables used as inputs in the system design optimization and manufacturing planning phase. The second VSCDP is also for a company having a GM&S, a BP, and an engineering unit. The GM&S, the BP, and the engineering unit in the second VSCDP, utilize techniques in the project planning phase, the concept demonstration ready phase, and the system design optimization and manufacturing planning phase in combination with predetermined inputs to create outputs. Each step throughout the second VSCDP also has a lead role, a support role (when applicable), the input from a previous step (if applicable), and the output/deliverable. The inputs and outputs mentioned through out the first VSCDP are not all-inclusive and may be used or added to as desired.

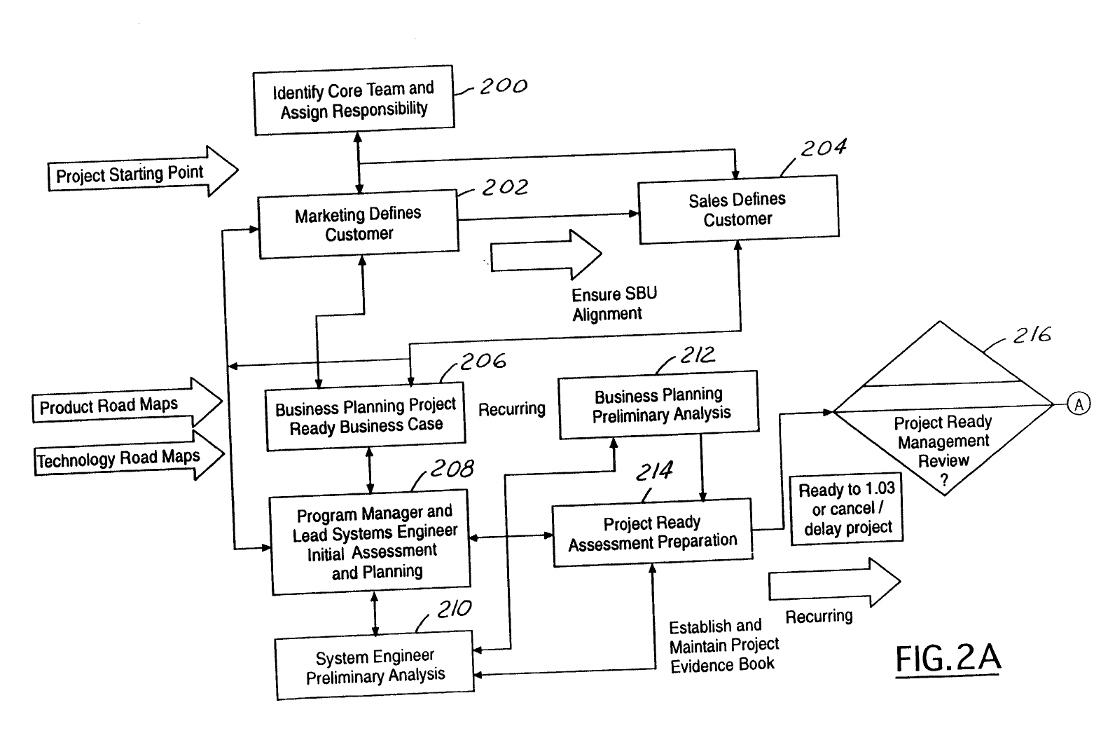

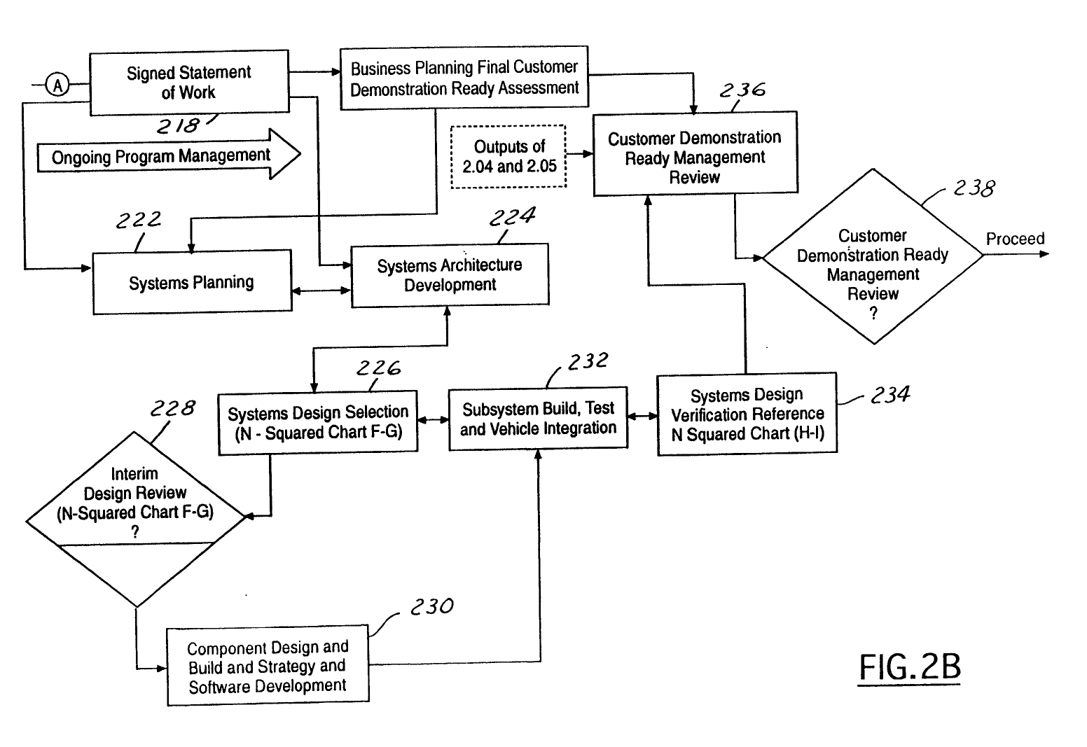

Now referring to FIG. 2A, the project ready phase of the second embodiment comprises preferably nine steps, each step containing techniques for the second embodiment.

In step 200, a core team is identified and the department management team (DMT) assigns team member responsibilities. The core team typically consists of the PM and the LSE. The BP and a marketing/sales representative are preferably assigned to support. The core team may also include key SEs as required. The project may be an organization's internal development effort or may be for an external, or customer, development interest. The customer may have unique vehicle system requirements for support for example on-site representation or program action team or program module team participation. The DMT performs the lead role. The input is desirables for the vehicle system being developed. The output is the assignment of the core team.

In step 202, a marketing representative (MR) defines the customer for the vehicle system. The MR may define the customer by identifying a need for a development vehicle system and delivering it to the responsible engineering development department manager. The MR may also support the core team to assess the market drivers for internal development vehicle systems. The MR performs the lead role. A sales representative, a technical sales representative, the BP, the PM, and the LSE perform support role. Sources of input include but are not limited to RFQs for related vehicle systems, vehicle subsystems, or components. Sources of input may also include direct dialog with OEM customers, trade/auto shows, web sites/internet, syndicated studies (consultants), trade magazines/technical papers, investor analysis, research information, customer annual reports, government regulations, or market research information. The output includes forecasts, product plans and OEM customer assessments based on geographical region, vehicle segment, OEM platform, vehicle model, manufacturing location, vehicle volumes, refresh opportunities, and technology trends. The output may also include marketing strategy summary specific to OEM customer while understanding OEM alliances/partnerships, having knowledge of OEM customer drivers, having an OEM business outlook, having an OEM technology outlook. The output may align with marketing target rationale and a vehicle attribute matrix, as discussed in step 68, including vehicle segment/consumer wants.

In step 204, sales and technical sales representatives court potential customers. Initial configurations may be proposed to the customer to help ensure customer mutual interest. Organizational support may be solicited to develop timing and an initial statement of work. The sales and technical sales representative performs the lead role. The BP, MR, technical experts, management team, PM, and the LSE perform the support role. The input is customer contact and a “boiler plate” of potential vehicle subsystems supplied by the LSE or PM. The output is the forecasts, product plans, and OEM customer assessments also based on customer future marketing plans. The output also includes a list of customer assumptions, an initial timing plan, and an initial statement of work. The output includes vehicle segment/consumer wants and a vehicle attribute matrix.

In step 206, the PM and technical sales representative assess the customer's interest in joint funding, collocation of people, and supply of vehicle information. Based on the assessment, the BP drafts an initial business case of the vehicle system. Marketing is used if a customer is not identified. The business case links vehicle system assumptions with the required resources and rationale. The BP and the technical sales representative perform the lead role. The PM, marketing and sales representatives, and LSE perform the support role. The input is the SBU/supplier product and technology roadmaps, forecasts and product plans, marketing strategy, customer assumptions and timing, vehicle segment/customer wants, and vehicle attribute matrix. The output is a project ready business case.

In step 208, the PM, LSE and supporting team members develop/clarify customer requirements and expectations to refine the initial statement of work. A first preliminary analysis is conducted, involving appropriate team members, to identify potential solutions to satisfy vehicle attribute matrix requirements. In addition a preliminary power consumption analysis is conducted. PM, LSE and supporting team create an initial vehicle system architecture and initial load partitioning. Buy-in and preliminary commitments are established from SEs on vehicle system requirements and program deliverables. The PM and the LSE perform the lead role. The BP, SEs, technical sales representative, and marketing and sales representatives perform the support role. The input is the initial statement of work, forecasts, product plans and OEM customer assessment(s), customer assumptions and timing, marketing strategy for vehicle segment and/or consumer wants, vehicle attribute matrix, and project ready business case. The output is the project ready statement of work, high-level subsystem requirement description, the initial vehicle system architecture, the initial load partitioning, a program work plan, and a preliminary power consumption analysis.

In step 210, the SE performs a second preliminary analysis. This analysis includes determining the best vehicle subsystem solution within vehicle system timing. The SEs and LSE ensure that the vehicle subsystem performs within the vehicle system architecture and load partitioning. SEs and BP work with the SBU's to define a roster of roles/responsibilities to support each vehicle subsystem deliverable. The SEs perform preliminary technical risk assessments with input from SBU's packaging assessment to determine feasibility. The SEs perform the lead role. The PM, LSE and the BP perform the support role. The input is the high-level subsystem requirement description, program work plan, initial vehicle system architecture, initial load partitioning, vehicle attribute matrix, and the initial statement of work. The output is the potential vehicle subsystem solutions, preliminary assessment of impact to vehicle attributes, project ready technical risk assessment, roster and roles/responsibilities.

In step 212, the BP performs a third preliminary assessment. The third preliminary assessment is preferably preformed simultaneously and in support of the second preliminary analysis. The BP and the SEs obtain a project ready business risk assessment, a project ready price analysis, and a SBU alignment through a preliminary program meeting with the SBU's. The BP and the SEs also de3velop key partnerships along with supplier confidential disclosure agreements on an as needed basis when technology/product/timing gaps are identified. The BP performs the lead role. The SEs performs the support role. The input is the high-level subsystem requirement description, program work plan, initial load partitioning, initial vehicle system architecture, vehicle attribute matrix, and the initial statement of work. The output is the project ready business risk assessment, project ready price analysis, SBU alignment, key partnership documentation, and confidential disclosure agreements.

In step 214, the project ready assessment is prepared. The PM and the LSE compile a project ready summary for management review. The PM and LSE perform the lead role. The BP and SEs perform the support role. The input is the outputs in steps 200 through 212. The output is the project ready summary.

In step 216, the PM coordinates a review of the preliminary deliverables from project ready summary with the department management team. Management reserves the option to send the team back to refine information or to cancel/delay the program. The lead role is performs by the PM. The core team performs the support role. The input is the project ready summary. The output is the management's decision to approve movement to the next phase, to send team back to refine information, or cancel/delay the program.

Now referring to FIG. 2B, the concept demonstration ready phase of the second embodiment includes preferably eleven steps, each step containing techniques for the second embodiment. The PM continuously tracks and updates the program work plan during this phase.

In step 218, all team members sign and finalize a project ready statement of work. The project ready statement of work may include internal development stakeholders and external stakeholders as necessary. Stakeholders may be internal or external customers.

In step 220, the BP performs an updated assessment. The BP, PM, and the LSE review the signed project ready statement of work to create a common understanding of the deliverables. BP will submit to the SBU's/suppliers a commitment request. The response to the commitment request is used to finalize the business case. The BP performs the lead role. The SBU BP, PM, LSE, and SEs perform the support role. The input is the signed project ready statement of work and the project ready business case. The output is the SBU/supplier commitment request, which may include a business risk assessment, price impact, value analysis, and quality and weight targets. The output also includes a customer demonstration ready business case.

In step 222, the LSE develops a systems engineer management plan that includes the following responsibilities: updating the roster and roles/responsibilities, identifying any development changes with regard to staffing needs, defining methods/tools to be used for vehicle level integration of vehicle subsystem designs to ensure support of high-level attributes established in project ready phase, reviews SBU/supplier product and technology roadmaps and establishes a technology integration strategy with contingencies. The LSE maintains/updates the above information through the completion of this phase. The LSE performs the lead role. The PM, BP, and SEs perform the support role. The input is the roster and roles/responsibilities, vehicle attribute matrix, and SBU/supplier product and technology roadmaps. The output is the systems engineer management plan.

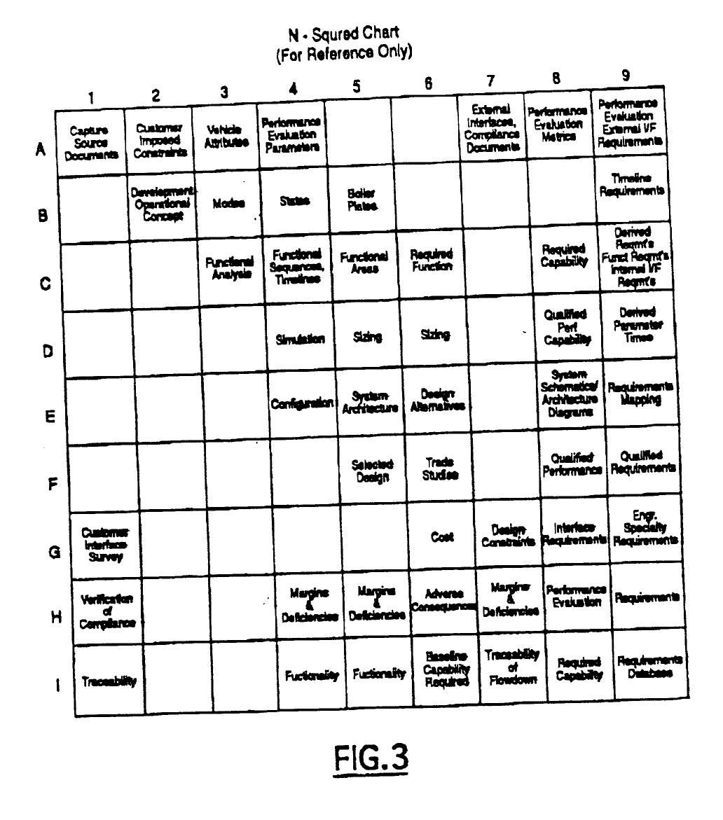

In step 224, the vehicle system architecture is developed. An N-squared chart (A-E), as best shown in FIG. 3, is referred to for details on engineering functions, sequence, and outputs. The vehicle system requirements are refined. If vehicle system requirements have changed since the project ready phase then the impact from the changes to the vehicle system is evaluated and a plan to address the changes is developed or refined. An operational concept is established and vehicle system diagrams and flowcharts are developed or refined. Mathematical methods, computer simulations, or other methods are used, as defined in a system engineering management plan, to develop architecture configurations to arrive at vehicle system and vehicle subsystem design alternatives, as known in the art. A customer demonstration ready technical risk assessment is developed for each vehicle system and vehicle subsystem architecture design alternative. It is likely that the vehicle system and vehicle subsystem designs will occur in parallel and both will be iterative and inter-dependent. A prior intellectual property search should be completed at this time and any unique intellectual property should be protected and filed. The LSE and SEs perform the lead role. The test engineer, SBU/Suppliers, PM, BP, technical sales representative, and marketing and sales representatives perform the support role. The input is the customer demonstration ready business case, outputs from the project ready phase, and the system engineering management plan. The output is a vehicle system requirements database, an operational concept, vehicle system architecture design alternatives, a simulation(s) summary of vehicle system architecture design alternatives effects on the vehicle attributes, the customer demonstration ready technical risk assessment, the intellectual property search, and the intellectual property protection filings.

In step 226, the vehicle system and vehicle subsystem designs are selected. The N-squared chart (F-G) is referred to in this step. If the vehicle system requirements have changed, the impact to the vehicle system is evaluated and a plan to address the changes is developed. Trade studies are performed, as defined in the system engineering management plan, to determine the best architecture that satisfies the vehicle system requirements. Design constraints such as timing, cost, and technology gaps are reviewed to verify that the chosen vehicle system or vehicle subsystem satisfies the vehicle system and vehicle subsystem requirements. Quantified performance expectations are recorded for the chosen vehicle system and vehicle subsystem architecture and documented in the vehicle system requirements documents and architecture module specifications. A preliminary SFMEA is completed to document the technical design constraints and to develop approaches to mitigate adverse consequences. The LSE and SEs perform the lead role. The test engineer, PM, BP, technical sales representative, and the marketing and sales representatives perform the support role. The inputs are the vehicle system architecture design alternatives, customer demonstration ready technical risk assessment, vehicle system requirements database, system engineering management plan, and the customer demonstration ready business case. The output is the trade studies' documentation including a summary of secondary and tertiary system/subsystem effect identified and a summary of vehicle attribute balance versus cost. The output also includes a vehicle system architecture design description, an updated vehicle system requirements database, quantified performance expectations, SRDs and architecture module specifications, and the preliminary SFMEA.

In step 228, management reviews the outputs of steps 224 and 226. Focus is on the chosen vehicle system and vehicle subsystem architecture designs. All vehicle system requirements and vehicle system goals are reviewed. Management decides to either continue, re-design, or cancel the concept under development. The vehicle system architecture design is summarized to demonstrate how vehicle system requirements are met and customer value in terms of reduced cost, improved robustness, added features, or other benefits are added. The LSE and PM perform the lead role. The support role is performed by the customers as appropriate, SEs, SBU representatives, supplier representatives, technical sales representative, and marketing and sales representatives. The input is the outputs of steps 224 and 226. The output is the vehicle system architecture design alternative summary and management's decision to either approve the vehicle system architecture design alternative, send team back to refine information, or cancel/delay the program.

In step 230, prototype components are designed, built, and tested to meet the systems requirement specifications and architecture module specifications. The project timing requirements are described in the program work plan. Prototype software is developed and tested. VPDS and/or local design practice results are documented and made available to the system engineer. The SBU/supplier engineers and advanced development engineer(s) perform the lead role. The SEs, SBU/supplier sales and BP representatives perform the support role. The inputs are the vehicle system requirements specifications, architecture module specifications, vehicle system design specifications, VPDS or local design practices. The output is the prototype component(s), control software, VPDS or local design practices documentation.

In step 232, the SEs develop the DVP&R using the SRDs, the architecture module specifications and/or other resources for test requirement reference. The initial subsystem builds proceed using the components/software supplied and vehicle system testing is done to ensure compliance at a vehicle level. The vehicle subsystem test plan and SFMEA are updated to incorporate the vehicle system test results. Vehicle system components or vehicle systems that do not meet customer requirements are evaluated with the appropriate engineer and a plan for corrective action is developed. The LSE and SEs coordinate the integration of vehicle subsystems into the vehicle and ensure proper operation. The SEs and LSE perform the lead role. The advanced development engineers, SBU's/supplier engineers, and test engineer perform the support role. The inputs are SRDs, architecture module specifications, or other resources for test requirements. The outputs are vehicle subsystem test plan, corrective action plan as required, updated SFMEA, and assembled vehicle.

In step 234, the vehicle test plan is developed and vehicle level testing is conducted. The recorded test data is used to evaluate the accuracy of simulations and models used in design. Vehicle level testing is performed to verify that the vehicle system requirements are satisfied per the vehicle test plan. Also, testing may help determine any margins, deficiencies, or adverse consequences not previously addressed. Based on test results, a customer demonstration ready technical risk assessment and SFMEA are updated. During testing and evaluation, possible serviceability issues are recorded in a preliminary serviceability assessment. Vehicle systems that do not satisfy the vehicle system requirements of the vehicle test plan are evaluated with the appropriate engineer(s) and a plan for corrective action is developed. Upon completion of this step the SEs document results and make recommendations to refine the vehicle system in the system design optimization and manufacturing planning phase. The vehicle system requirements database is updated. The SEs bookshelf the vehicle system/subsystem designs and record lessons learned. The SEs and LSE perform the lead role. The test engineer performs the support role. The inputs are the vehicle subsystem test plan, SRDs, architecture module specifications, SFMEA, vehicle system requirements database, and customer demonstration ready technical risk assessment. The outputs are the vehicle test plan, benefits of vehicle system architecture design alternative(s) summarized and supported by test data, a summary of simulation models'accuracy, an updated customer demonstration ready technical risk assessment, an updated SFMEA, the preliminary serviceability assessment, a corrective action plan, recommendations of how to refine the vehicle system for the system design optimization and manufacturing planning phase, an updated vehicle system requirements database, updated SRDs and architecture module specifications, a bookshelf design, and a lessons learned summary.

In step 236, the PM and the LSE evaluate the vehicle and associated documents to compile a customer demonstration ready summary for a customer demonstration ready management review. The PM and LSE perform the lead role. The BP, technical sales representative, marketing and sales representatives, and system engineers perform the support role. The input is the outputs from steps 216 through 234 as applicable. The output is the customer demonstration ready summary.

In step 238, the PM coordinates a review of the primary deliverables from the concept demonstration ready phase with the department management team. Management may send the team back to refine information or to cancel/delay the program. The lead role is performed by the PM. The core team performs the support role. The input is the customer demonstration ready summary. The output is the customer demonstration ready vehicle and the management's decision to either approve the program, send team back to refine vehicle and/or information, or cancel/delay the program.

While particular embodiments of the invention have been shown and described, numerous variations alternate embodiments will occur to those skilled in the art. Accordingly, it is intended that the invention be limited only in terms of the appended claims.

What is claimed is:

1. A process for vehicle systems concept development by a company having a global marketing and sales unit, a business planning unit, and an engineering unit, said process comprising:
utilizing system program planning techniques wherein said system program planning techniques are used by said global marketing and sales unit, said business planning unit, and said engineering unit in combination with predetermined inputs to create outputs;
utilizing requirements driven customer ready development techniques wherein said requirements driven customer ready development techniques are used by said global marketing and sales unit, said business planning unit, and said engineering unit in combination with predetermined inputs to create outputs; and
utilizing system design optimization and manufacturing planning techniques wherein said system design optimization and manufacturing planning techniques are used by said global marketing and sales unit, said business planning unit, and said engineering unit in combination with predetermined inputs to create outputs.

2. A process as in claim 1 wherein said engineering unit comprises a vehicle system management unit, a lead vehicle system engineer, a vehicle functional system engineer, an enabling technologies/research group, and a strategic business unit (SBU) engineering and strategic partners group.

3. A process as in claim 1 wherein said system program planning techniques for said global marketing and sales unit comprises:
creating a proposal;
gathering,vehicle system assumptions and timing;
identifying vehicle segment wants;
establishing vehicle metrics; and
creating a market portfolio.

4. A process as in claim 3 further comprising:
responding to said proposal;
creating a concept description;
acquiring target market data;
generating product plans;
generating a market strategy; and
developing market forecasts.

5. A process as in claim 1 wherein said system program planning techniques for said business planning unit comprises:
defining vehicle system objectives;
defining a business plan;
obtaining a SBU alignment;
defining a pricing strategy;
obtaining capital funds and budgets; and
performing a business case analysis.

6. A process as in claim 2 wherein said system program planning techniques for said vehicle system management unit comprises:
establishing a system evidence book;
forming a team;
defining said team roles and responsibilities;
defining vehicle system requirements;
preparing a vehicle system plan and a 7-panel chart;
establishing metrics;
design system attribute targets; and
reviewing vehicle system plan.

7. A process as in claim 2 wherein said system program planning techniques for said lead vehicle system engineer comprises:
designing vehicle systems steps including vehicle systems methodologies and tools;
establishing power generation architecture assumptions and power budget;
translating said assumptions into system technical assumptions; and
identifying technology gaps.

8. A process as in claim 2 wherein said system program planning techniques for said vehicle functional system engineer comprises:
establishing subsystem team roster and roles;
conducting a subsystem benchmark study;
establishing a patent strategy;
creating a vehicle subsystem plan;
creating a vehicle system green, yellow, red (GYR) status report; and
developing make/buy analysis and sourcing plans.

9. A process as in claim 2 wherein said system program planning techniques for said enabling technologies/research group comprises:
determining product and technology gaps;
establishing product and technology plans;
establishing a vehicle system GYR status report; and
establishing product and technology assumptions.

10. A process as in claim 2 wherein said system program planning techniques for said SBU engineering and strategic partners group comprises:
defining a team roster and roles;
creating a baseline for power consumption;
identifying product and technology desires; and
establishing said make/buy analysis and said sourcing plans.

11. A process as in claim 1 wherein said requirements driven customer ready development techniques for said global marketing and sales unit comprises creating marketing displays and brochures.

12. A process as in claim 1 wherein said requirements driven customer ready development techniques for said business planning unit comprises:
updating a business case and pricing; and
defining implementation ready vehicle system plan and resources.

13. A process as in claim 2 wherein said requirements driven customer ready development techniques for said vehicle system management unit comprises:
updating said vehicle system plan and a system evidence book;
compiling and managing attribute data;
defining hardware desires;
developing build sheets;
creating a vehicle system design validation plan;
generating customer ready hardware yellow board test reports;
building and validating a proof of principle vehicle;
generating customer ready report; and
generating a customer ready summary.

14. A process as in claim 2 wherein said requirements driven customer ready development techniques for said lead vehicle system engineer comprises:
defining system operational behavior and strategies;
detailing system requirements;
performing an interface analysis;
reviewing technical vehicle system requirements;
performing a logical solution partitioning and first trade study;
developing preliminary customer ready system layouts and schematics;
performing a physical subsystem partitioning and second trade study;
developing final customer ready layouts and component drawings;
reviewing a critical design;
defining overall vehicle system requirements; and
creating a system development validation process.

15. A process as in claim 14 wherein said detailing system requirements further comprises:
defining subsystem attribute targets;
defining system boundaries;
defining life cycle requirements and constraints;
reviewing functional system design specifications (SDSs);
identifying applicable vehicle system requirements;
creating system requirements document (SRD); and
creating a boundary diagram.

16. A process as in claim 14 wherein said performing an interface analysis further comprises:
defining external interfaces and secondary impacts;
assigning applicable vehicle system requirements to indirect or direct interfaces; and
creating an interface control document.

17. A process as in claim 14 wherein said performing a logical solution partitioning and first trade study further comprises:
conducting a functional analysis;
creating customer ready concepts;
defining alternative vehicle system configurations for customer ready;
identifying selection criteria;
performing a first trade study; and
describing a preliminary architecture.

18. A process as in claim 14 wherein said performing a physical subsystem partitioning and second trade study further comprises:
updating customer ready reports;
re-defining alternative vehicle system configurations for customer ready;
verifying selection criteria; and
selecting final system architecture and a load partition for customer ready.

19. A process as in claim 2 wherein said requirements driven customer ready development techniques for said vehicle functional system engineer comprises:
gathering subsystem operational modes and states;
updating vehicle system plans and vehicle system status updates;
defining system operational behavior and strategies;
performing a detailed vehicle subsystem requirements capture;
performing an interface analysis;
performing a logical solution subsystem partitioning and third trade study;
performing a physical subsystem partitioning and fourth trade study;
developing preliminary customer ready layouts;
defining a design verification plan;
integrating and delivering a subsystem; and
conducting proof of principle.

20. A process as in claim 19 wherein updating vehicle system plans and vehicle system status updates further comprises:
establishing a subsystem evidence book;
implementing and managing a project plan; and
reviewing bookshelf for re-usable deliverables.

21. A process as in claim 19 wherein performing a detailed vehicle subsystem requirements capture further comprises:
defining vehicle system boundaries;
identifying vehicle subsystem attributes applicable to components and assign targets;
defining life cycle requirements and constraints;
creating a system requirements document (SRD);
reviewing a functional SDS;
identifying applicable vehicle subsystem requirements; and
defining verification methods.

22. A process as in claim 19 wherein performing an interface analysis further comprises:
defining external interfaces and secondary impacts;
assigning applicable vehicle subsystem requirements to interfaces; and
creating vehicle subsystem interface control documents.

23. A process as in claim 19 wherein performing a logical solution subsystem partitioning and third trade study further comprises:
creating customer ready concepts;
defining alternative vehicle subsystem configurations for customer ready;
identifying selection criteria; and
performing a third trade study to select a final subsystem architecture for customer ready.

24. A process as in claim 2 wherein said requirements driven customer ready development techniques for said enabling technologies/research group comprises:
implementing a management vehicle system plan;
defining an intellectual property and patent strategy;
performing a feasibility analysis on development plans of suppliers and functional units;
transforming technology development plans into implementation plans;
performing a components requirement capture;
creating a component design;
establishing product cost;
performing customer build and customer ready verification.

25. A process as in claim 24 wherein said performing a components requirement capture further comprises:
translating component attribute targets into design constraints; and
defining component requirements and preliminary concept development process.

26. A process as in claim 24 wherein said creating a component design further comprising:
defining a design verification plan and report;
completing detailed component design;
performing a design failure modes effects analysis (DFMEA); and
submitting invention disclosures.

27. A process as in claim 24 wherein said performing customer build and customer ready verification further comprises:
building and delivering component hardware;
conducting a component verification and validation; and
ensuring packaging compatibility in vehicle.

28. A process as in claim 2 wherein said requirements driven customer ready development techniques for said SBU engineering and strategic partners group comprises:
implementing and managing a vehicle system plan;
updating said vehicle system plan;
establishing component customer ready hardware, verification and validation reports, component drawings, a DFMEA, component requirements, component design specification, manufacturing and product detail; and
completing initial cost and attribute analysis.

29. A process as in claim 1 wherein said system design optimization and manufacturing planning techniques for said global marketing and sales comprises:
determining which vehicle segments to target;
identifying appropriate customers;
responding to a request for quote (RFQ); and
generating an implementation ready contract.

30. A process as in claim 1 wherein said system design optimization and manufacturing planning techniques for said business planning comprises:
identifying customer ready process steps;
determining the vehicle system scope; and
completing a detailed implementation ready business case analysis.

31. A process as in claim 2 wherein said system design optimization and manufacturing planning techniques for said vehicle system management comprises:
implementing and managing a vehicle system plan;
developing an implementation ready report; and
deciding on implementation readiness.

32. A process as in claim 2 wherein said system design optimization and manufacturing planning techniques for said lead vehicle system engineer comprises:
performing production intent partitioning;
performing a system optimization trade study;
developing preliminary said system layouts;
finalizing cascade of vehicle system requirements to vehicle subsystems;
performing a system metrics and risk analysis;
conducting a detailed system bookshelf review; and updating bookshelf.

33. A process as claim 32 wherein said performing production intent partitioning further comprises:
defining internal interfaces;
developing architecture/partitioning; creating concepts; and
defining alternative system configurations.

34. A process as claim 32 wherein said performing system optimization trade study further comprises:
identifying vehicle system requirements that drive design;
identifying selection criteria;
identifying primary alternatives; creating hybrids; and
performing a system optimization trade study.

35. A process as claim 32 wherein said performing a said system metrics and risk analysis further comprises:
freezing a system architecture and design;
completing analysis of technical measures and attributes; and
finalizing a system failure modes effects analysis (SFMEA).

36. A process as in claim 2 wherein said system design optimization and manufacturing planning techniques for said vehicle functional system engineer comprises:
performing production intent partitioning;
performing a vehicle subsystem optimization trade study;
cascading vehicle subsystem attributes and requirements to components;
developing vehicle subsystem layouts;
defining computer aided engineering and computer aided drafting requirements; and
performing subsystem metrics and risk analysis.

37. A process as claim 36 wherein said performing production intent partitioning further comprises:
defining internal interfaces;
developing architecture/partitioning;
creating concepts; and
defining alternative vehicle system configurations.

38. A process as claim 36 wherein said performing a vehicle subsystem optimization trade study further comprises:
identifying said vehicle system requirements, which drive design;
identifying selection criteria;
performing analysis to identify primary alternatives and create hybrids; and
performing subsystem optimization trade study to select final vehicle subsystem architecture.

39. A process as claim 36 wherein said performing subsystem metrics and risk analysis further comprises:
defining attribute data and detailed cost analysis; and
finalizing subsystem SFMEA.

40. A process as in claim 2 wherein said system design optimization and manufacturing planning techniques for said enabling technologies/research group comprises updating bookshelf.

41. A process as in claim 2 wherein said system design optimization and manufacturing planning techniques for said SBU engineering and strategic partners group comprises:
updating bookshelf; and
performing a strategic business unit concept development process.

42. A method for vehicle system concept development by a company comprising: utilizing and incorporating skills from a plurality of organizational units and an engineering unit throughout the process.

43. A method as in claim 42 wherein the company uses a market driven set of requirements fed into a systems engineering approach to develop and validate a vehicle system design solution to satisfy the market driven set of requirements.

44. A process as in claim 43 wherein said plurality of organizational units comprises a marketing unit.

45. A process as in claim 43 wherein said plurality of organizational units comprises a sales unit.

46. A process as in claim 43 wherein said plurality of organizational units comprises a business planning unit.

47. A process as in claim 43 wherein said plurality of organizational units comprises a program management unit.

48. A process as in claim 43 wherein said plurality of organizational units comprises a plurality of suppliers.

49. A process for vehicle system concept development by a company having a program management unit, a marketing and sales unit, a business planning unit, and an engineering unit, the process utilizes and incorporates skills from the program management unit, the marketing and sales unit, the business planning unit, and the engineering unit throughout the process.

50. A process for vehicle systems concept development by a company having a global marketing and sales unit, a business planning unit, and an engineering unit, said process comprising:
utilizing project ready techniques wherein said project ready techniques are used by said global marketing and sales unit, said business planning unit, and said engineering unit in combination with predetermined inputs to create outputs;
utilizing concept demonstration ready techniques wherein said concept demonstration ready techniques are used by said global marketing and sales unit, said business planning unit, and said engineering unit in combination with predetermined inputs to create outputs; and
utilizing application ready techniques wherein said application ready techniques are used by said global marketing and sales unit, said business planning unit, and said engineering unit in combination with predetermined inputs to create outputs.

51. A process as in claim 50 wherein said engineering unit comprises a vehicle system management unit, a lead vehicle system engineer, a vehicle functional system engineer, an enabling technologies/research group, or a strategic business unit (SBU) engineering and strategic partners group.

52. A process as in claim 51 wherein said project ready techniques comprise:
assigning a core team;
creating a vehicle attribute matrix;
creating a project ready business case;
performing initial assessment and planning;
performing a system engineer preliminary analysis;
performing a business planning preliminary assessment;
creating a project ready summary; and
receiving a management approval to proceed.

53. A process as in claim 52 wherein said performing an initial assessment and planning further comprises:
creating a project ready statement of work;
establishing a high-level subsystem requirement description;
developing initial system architecture;
performing an initial load partitioning;
creating a work plan; and
performing a preliminary power consumption analysis.

54. A process as in claim 52 wherein said performing a system engineer preliminary analysis further comprises:
developing potential vehicle subsystem solutions;
creating a preliminary assessment of impact to vehicle attributes; and
creating a project ready business risk assessment.

55. A process as in claim 52 wherein said performing a business planning preliminary assessment further comprises:
performing a project ready price analysis;
creating an SBU alignment;
creating key partnership documentation; and
developing confidential disclosure agreements.

56. A process as in claim 51 wherein said concept demonstration ready techniques comprise:
performing a business planning final assessment;
creating a system engineering management plan;
performing systems architecture development;
performing a system design selection;
beginning vehicle planning and definition stage or local design practices documentation;
performing subsystem build and vehicle integration;
performing systems design verification;
creating a customer demonstration ready summary; and
performing a customer demonstration ready management review.

57. A process as in claim 56 wherein said performing a business planning final assessment further comprises:
receiving a SBU/supplier commitment request; and
developing a customer demonstration ready business case.

58. A process as in claim 56 wherein said performing a systems architecture development further comprises:
creating a vehicle system requirements database;
developing an operational concept;
developing vehicle system architecture design alternatives;
summarizing a simulation of system architecture design alternatives effects on vehicle attributes;
performing a customer demonstration ready risk assessment;
performing an intellectual property search; and
performing intellectual property protection filings.

59. A process as in claim 56 wherein said performing systems design selection further comprises:
performing trade studies;
creating a system architecture design description;
quantifying performance expectations;
updating vehicle system requirements documents and architecture module specifications; and
performing a system failure mode effects analysis.

60. A process as in claim 56 wherein said performing system design selection further comprises:
summarizing vehicle system architecture design alternatives; and
receiving a management's decision.

61. A process as in claim 56 wherein said performing subsystem build and vehicle integration further comprises:
creating a vehicle subsystem test plan;
performing a corrective action plan; and
creating an assembled vehicle.

62. A process as in claim 56 wherein said performing systems design verification further comprises:
summarizing the benefits of system architecture design alternatives;
summarizing simulation models' accuracy;
recommending how to refine vehicle system or subsystem;
developing a bookshelf design; and
summarizing lessons learned.

63. A process as in claim 56 wherein said performing a customer demonstration ready management review further comprises:
developing a customer demonstration ready vehicle; and
receiving a management's decision to approve the vehicle system.
